(19) United States
(12) Patent Application Publication
(10) Pub. No.: US 2024/0177171 A1
(43) Pub. Date: May 30, 2024

(54) ARTIFICIAL INTELLIGENCE AND MACHINE LEARNING POWERED CUSTOMER EXPERIENCE PLATFORM

(71) Applicant: Sutherland Global Services Inc., Pittsford, NY (US)

(72) Inventors: R Thangappa, Guduvanchery (IN); Krishna Reddy, Hyderabad (IN); Thuthku Naresh Babu, Telangana (IN); Kandapaturi Naveen Kumar, Nellore (IN); Sakyasingha Mohapatra, Bangalore (IN); S R Prabhakar Daley, Hyderabad (IN); Soumyakant Mallick, Hyderabad (IN); Navaneethan Thirumurthy, Fushear, TX (US)

(73) Assignee: Sutherland Global Services Inc., Pittsford, NY (US)

(21) Appl. No.: 18/058,905

(22) Filed: Nov. 28, 2022

(51) Int. Cl. G06Q 30/015

(52) U.S. Cl. CPC G06Q 30/015

(57) ABSTRACT

An artificial intelligence (AI) and machine learning (ML) powered customer experience intelligence platform is adapted to collect interaction data and metadata associated with interactions between customer computing devices and agent computing devices, generate a transcript for each interaction between the customer computing devices and the agent computing devices based on the collected data, apply AI/ML model(s) to the transcripts to perform deep analytics and interaction monitoring to generate interaction insights for each interaction, and predict scores rating agent behavior during each interaction, and display the predicted scores and the generated interaction insights on a graphical user interface, for example, a dashboard.

### FIELD OF THE INVENTION

The present invention is directed to a system, method and program product for collecting and analyzing data associated with interactions between customers and customer service agents. In particular, the present invention is a system including a computing device that is programmed with artificial intelligence and one or more machine learning algorithms to generate actionable insights from the interaction data and provide the insights along with various scores indicative of predicted outcomes to users in a graphical user interface (GUI), for example, a dashboard, to improve the customer experience. Additional features and advantages are also set forth herein.

### BACKGROUND OF THE INVENTION

Customer support systems can drive differentiated consumer experience and growth in a variety of ways. As consumers make their experience a top reason to choose brands, a consumer-focused, digitally connected and brand consistent consumer care program elevates a given brand's reputation in the eyes of the consumer, while managing operation efficiency and increasing relevance. By listening intently and learning from each consumer interaction, and delivering delightful experiences and effectively addressing issues, consumer care programs can drive brand loyalty, create vocal champions that can be digitally activated, and drive revenue growth.

Currently, customer support systems rely on operations driven decision making using key performance indicators (KPIs) like average handling time (AHT), provide only market research and consumer feedback survey-based consumer insights, and require human based quality monitoring. One challenge in a customer support program is to proactively identify the resolution rates, customer sentiment, and customer satisfaction (CSAT) scores and/or net promoter scores (NPS) scores.

### SUMMARY OF THE INVENTION

The present invention uses computer-automation techniques and predictive models to measure all customer interactions and dynamically generate critical insights, which otherwise would take days or weeks to obtain using conventional techniques, and make these insights available in near real-time (e.g., within minutes, hours, or the same day) to transform their customer experience. These insights would help in real-time interventions that brings in higher resolution rates and customer satisfaction scores.

The improved customer support system described herein will facilitate outcomes driven decision making using KPIs like predictive resolution and CSAT/NPS, enable mining actual consumer interactions to drive consumer insights, and provide machine-assisted quality monitoring using artificial intelligence and machine learning (AI/ML models). By applying advanced AI and ML techniques including natural language processing (NPL), deep learning, and predictive modeling on consumer data to unlock the potential of rich customer interaction and feedback data, the consumer care program will be enabled to act on the right intelligence to drive meaningful transformation in business outcomes.

In order to address these and other needs, the invention described herein is an artificial intelligence (AI) and machine-learning (ML) powered customer experience intelligence platform that automates the process of monitoring and scoring of interactions across voice, chat, email, and social media channels. Some key features of the solution include generating interaction insights, performing quality monitoring automation, and deriving predictive outcomes related to the customer experience. The invention tracks interaction(s), e.g., every interaction, and applies natural language processing (NLP) and ML techniques to generate actionable insights that improve the customer experience. The solution significantly reduces the time and effort required for the quality audit process and identifies improvement opportunities across resolving customer queries, improving customer satisfaction and agent training. The invention also provides insights on the top call drivers and its relative resolution rates and customer satisfaction scores.

The invention described herein can automate interaction transfer from a client system to the AI/ML based customer experience intelligence platform for analysis, monitor the interactions for the client, e.g., continuously, enable an audit for interactions, e.g., a 100% audit for all interactions happening within the program for effective insights, and provide feedback on various applicable business metrics. Proprietary AI models are built in at least four areas: (1) call/chat driver, (2) resolution, (3) quality parameter measurement, and (4) customer NPS, for example. The invention provides, for example, the ability to enhance agent performance with respect to their Quality Audit (QA) scores, resolution rate, handling time of chat, and customer NPS in the interactions handled by them. Thus, the invention improves the resolution rates, AHT, and NPS of the overall customer service program.

Customers and clients can define and add metrics to be measured and audited on the interactions, and can set targets for the metrics. The system parses the interactions using the AI/ML models and scores each interaction giving insights on one or more performance metrics for a specific interaction, for a specific agent or customer service representative, for a team of CSRs/agents, etc. The AI solution described herein can use text mining and machine learning algorithms to produce insights that business stakeholders can leverage to improve business metrics that truly impact the customer experience and focus the teams on improving deficiencies leading to high Net Promoter Score (NPS).

The invention provides the ability to see performance of various agents, teams, and programs, drill down to individual performance of agents for individual business metrics. The invention also provides flexibility to provide coaching inputs by supervisors (e.g., managers or coaches) to the agents based on pain points identified for the agent, team, or program. Supervisors can “slice and dice” (e.g., manipulate, filter, sort, etc.) the performance metrics and can quickly identify the top and bottom performers for the metrics. The supervisors can also coach agents individually by looking at session details, and use the insights from the top performers interactions to coach the bottom performers. The system provides the ability to take action in the form of future goals for helping agents to improve via a goal management feature, and reward agents and/or teams for exemplary behavior and improvements. Online coaching and mentoring inputs, along with coaching plans assigned to the CSRs or agents, helps to manage the customer support program effectively and efficiently. Thus, these dynamically generated insights help in real-time inventions, which ultimately results in higher resolution rates and customer satisfaction scores.

Some other potential outcomes of deploying an intelligent AI-enabled Quality Audit Solution (QA.ai) include but are not limited to: moving from low sampling of interactions for Quality Audit to higher sampling or complete (100%) auditing; automated and non-linear Quality Audit and Monitoring; metrics monitored, analyzed and reported to ensure increase in first call resolution (FCR) and increase in CSAT/NPS scores; quality metrics available quickly to manage performance and improve quality; coaching and mentoring by supervisors, along with online coaching plan and progress tracking; team dashboards and scorecards with different manager and agent views; and unified metrics across teams and possibly across channels.

Additional benefits of the above-described invention for generating interaction insights to improve the customer experience are set forth in the following discussion.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawings, wherein:

FIGS. 1A and 1B are diagrams showing an example system for generating interaction insights and other information in accordance with one or more aspects of the present invention;

FIG. 2A is a diagram illustrating value potential that uncovering interaction insights and acting on them yields tangible benefits for a client consumer care program, in accordance with one or more aspects of the present invention;

FIG. 2B is a diagram illustrating various use cases for connect analytics, in accordance with one or more aspects of the present invention;

FIG. 3A is a flow diagram of a process for training a machine learning model for NPS/CSAT/Resolution prediction, in accordance with one or more aspects of the present invention;

FIG. 3B is a flow diagram of a process for training a machine learning model for survey feedbacks analysis, in accordance with one or more aspects of the present invention;

FIGS. 4A and 4B show a flow chart and a diagram corresponding to a method for generating and displaying actionable insights and predictive scores based on analyzing collected interaction data using artificial intelligence and one or more machine learning models, in accordance with one or more aspects of the present invention;

FIG. 5 is a diagram illustrating a high level architecture of the system and method for generating and displaying actionable insights and predictive scores based on analyzing collected interaction data using AI/ML technologies, in accordance with one or more aspects of the present invention;

FIGS. 6A through 6K show examples of simplified graphical user interface (GUI) screens including examples of detailed dashboards for viewing by users, in accordance with one or more aspects of the present invention;

FIGS. 6H through 6K are simplified examples of additional content fields for GUI screens, in accordance with one or more aspects of the present invention; and

FIG. 7 is a block diagram illustrating an example of a computing environment in which the invention may be implemented, in accordance with one or more aspects of the present invention.

### DETAILED DESCRIPTION OF THE INVENTION

As used herein, the term “real time” when used with: communicating coaching feedback from a coach computing device to at least one agent computing device based on predicted score(s) and generated interaction insight(s); communications between agent computing device(s) and the coach computing device regarding the coaching feedback, refers to user perception of the time it takes to receive such communications. For example, while a second may be considered slow for computer processing, it would generally be perceived as fast by a user.

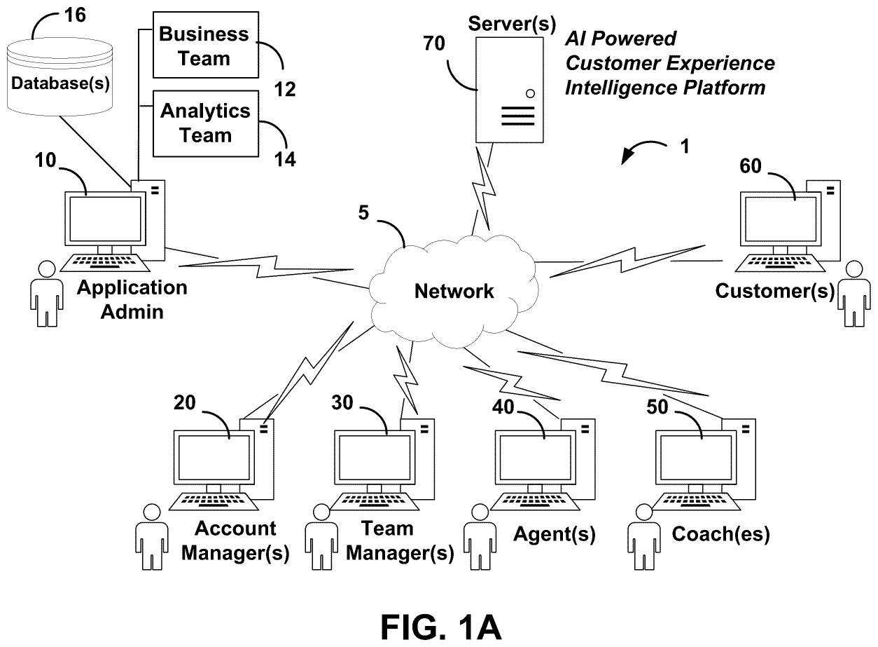

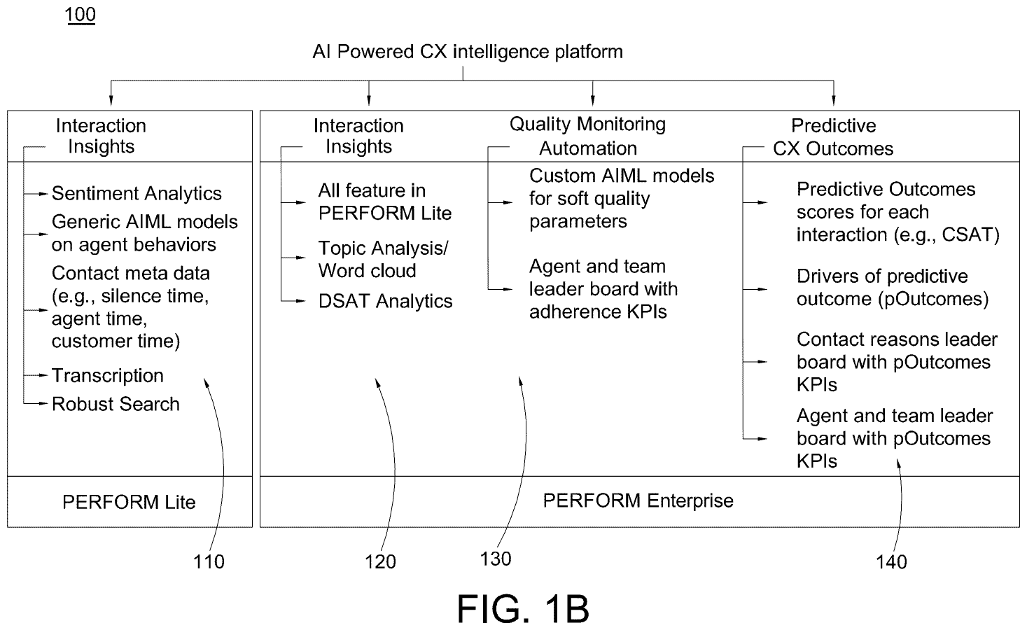

Referring to the drawings in detail, with particular reference to FIGS. 1A and 1B, an aspect of the present invention includes, for example, a system 1 that may be used to implement an algorithmic method for generating interaction insights, as well as performing quality monitoring automation and predicting customer experience outcomes. Other aspects of the present invention will be discussed in more detail below.

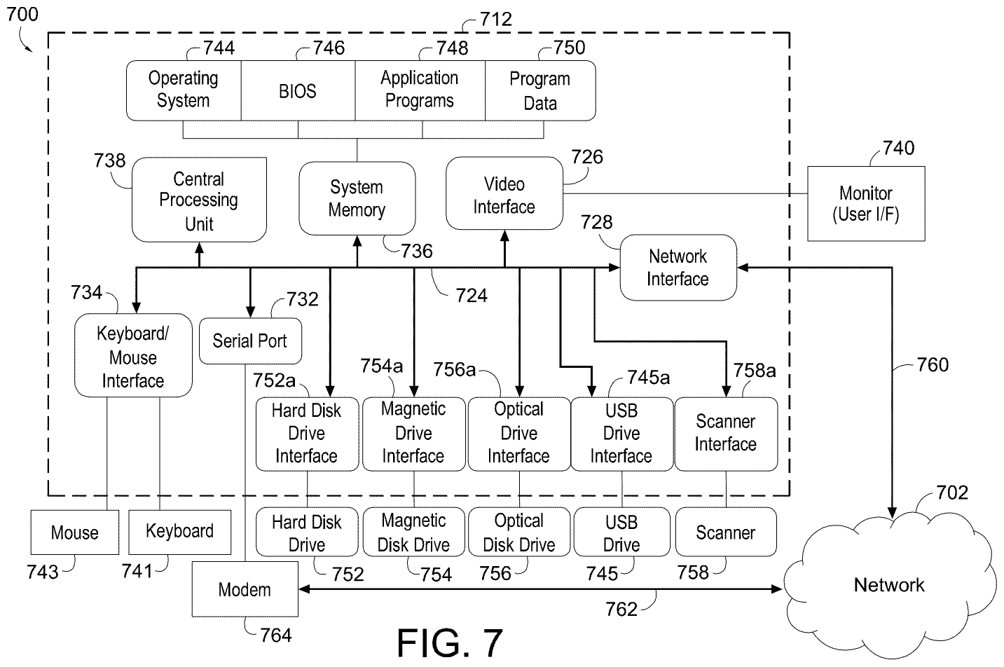

The system 1 shown in FIG. 1A may be implemented using one or more computing devices (refer to FIG. 7 for detailed examples) in communication over a network 5 which may include, for example, the Internet and/or a cloud computing environment through various wired and/or wireless connections. Examples of the one or more computing devices of system 1 may include a client computing device 10 (administrative user), an account manager computing device 20, one or more team manager computing devices 30, one or more agent computing devices 40, one or more coach computing devices 50, and one or more customer computing devices 60. Client computing device 10 may also be in communication with other computing and/or electronic devices, such as that for a business team 12 and one for an analytics team 14, and/or one or more databases 16. In particular, system 1 may further include, for example, one or more servers 70 for storing and/or executing computer-executable code that performs the functionality set forth in this application related to an AI-powered customer experience intelligence platform (also refer to system 100 of FIG. 1B). Each computing device may include, for example, a processor and a memory, which may have various programs, applications, logic, algorithms, instructions, etc. stored therein. As such, the invention is not limited to any specific hardware or software configuration, but may rather be implemented as computer executable instructions in any computing or processing environment, including, for example, in digital electronic circuitry or in computer hardware, firmware, device driver, or software. The various computing devices involved may include clients, servers, storage devices and databases, personal computers, mobile devices such as smartphones and tablets, or other similar electronic and/or computing devices. One or more of the computing devices (e.g., server 70, and/or one or more of computing devices 10, 20, 30, 40, 50 in FIG. 1A) may be programmed with computer executable instructions that implement one or more machine learning (ML) algorithms for performing a variety of interaction data analytics as described herein. Some ML algorithms may be trained using training data sets, which may be adapted for pattern recognition and scoring techniques and updated over time to refine the models using new data and additional customized learning parameters.

As best seen in FIG. 1B, system 100 (also referred to as server 70 of FIG. 1A, which is one example of a hardware computing device that can be used to implement system 100 of FIG. 1B) is an artificial intelligence (AI) powered customer experience intelligence platform that may have multiple editions with differing levels of functionality, for example, “Lite” and “Enterprise” editions generally covering the following areas, for example.

In one example, a “Lite” edition (partial functionality) may operate to generate interaction insights (110) using, for example, the following information and techniques: a) sentiment analytics, b) generic AI/ML models on agent behaviors, c) contact metadata (e.g., silence time, agent time, customer time), d) transcription, and e) robust search. Sentiment analytics includes analysis of conversation(s) between a customer and an agent using deep learning and machine learning that are built to understand the overall sentiment of the customer at the end of the conversation. Generic AI/ML models on agent behaviors are deep learning algorithms built based on experience over an extended period of time, e.g., months or years, to analyze the conversations and show insights on the behaviors displayed by the agent (e.g., effective probing, actively listening to customer, showing empathy, setting expectations, etc.). The transcriptions can be stored, for example, in database(s) and come from voice recordings, chat conversations, email conversations, social media conversations, etc. For voice recordings, transcriptions may be generated using an infrastructure built on deep learning and Graphics Processing Unit (GPU) technologies versus conventional processors as they are faster at processing, due to the processing need of online games, for example. For the other text-based communication channels, the unstructured data is cleansed and persisted for further processing. Searches may be performed on the conversations transcriptions, and on metadata for the conversations, using natural language processing (NLP) based techniques that help to filter the data quickly and easily. A typical timeline to enable the “Lite” edition deployment (e.g., 4-6 weeks) includes data acquisition and data integration, inference on one month historical data and categories configuration, and onboarding and training before going live.

In another example, an Enterprise edition (full featured) may operate to generate interaction insights (120) using the same features described above for the Lite edition, plus, for example: f) topic analysis and/or word clouds, and g) customer dissatisfaction (DSAT) analytics (e.g., derived from CSAT survey). Topic analysis is the concept of inferring the “key topic” of the conversations (e.g., billing questions, cancel an account, order queries, etc.). The word cloud shows some of the keywords (e.g., unigrams and bigrams) that were in the conversation between the customer and the agent, and may be, for example, based on the number of instances that specific words are used and showing, listing or emphasizing the words used more frequently. DSAT analytics is based on the insights from the customer survey response data, whereby the customer survey responses are analyzed using NLP, deep learning, and machine learning techniques. The enterprise edition may also, for example, operate to provide quality monitoring automation (130) utilizing, for example: a) custom AI/ML models for soft quality parameters, and b) agent and team leader board(s) with adherence key performance indicators (KPIs). The soft quality parameters focus on communication and language aspects as specified by a given customer of the platform. For example, different platform customers may have nuances for what qualifies as greeting their customers. The enterprise edition may also provide for Predictive Customer Experience (CX) outcomes (140) utilizing, for example: a) predictive outcomes scores for each interaction (e.g., predict CSAT survey results), b) drivers of predictive outcome (pOutcomes), c) contact reasons leaderboard with pOutcomes KPIs (filter/sort by interaction type), d) agent and team leaderboard(s) with pOutcomes KPIs (filter/sort by individual customer service representative (CSR)/agent or by groups of agents). “Contact reasons” are the topics for which a customer has reached out, for example, billing inquiries, order status, etc. The contact reasons are identified by analyzing the conversation between the customer and the agent using, for example, NLP techniques. The predictive outcomes may be aggregated at the “contact reason” level and insights may be given.

A typical timeline to enable the “Enterprise” edition deployment (e.g., about 16 weeks) may include the following example phases: (1) data acquisition, (2) batch 1 quality audit KPIs and customer insights categories definitions, (3) batch 2 quality audit KPIs and CSAT model development, (4) batch 3 quality audit KPIs and consumer insights operationalized, (5) CSAT model validation and finalization, (6) user acceptance testing (i.e., end-user beta testing), and (7) checking and preparation to go live. There may be 7-10 quality audit KPIs, for example, and the timeline ultimately depends, for example, on the data quality and the complexity to configure and optimize the ML models for each client's data.

Engagements using the AI/ML based platform described herein are designed to systematically elevate analytics maturity and improve customer experience by analyzing, predicting, and acting on intelligence from one or more interactions (including, for example, all interactions) between a customer and a CSR or agent. In one aspect, the invention enables AI/ML-based automation of agent behaviors and sentiment analytics. In another aspect, the invention provides predictive analytics to link interaction attributes to outcomes of interest (e.g., CSAT/NPS, first call resolution (FCR)), and automation of quality monitoring forms. In a further aspect, the invention provides prescriptive collaboration analytics to drive guided and proactive performance improvement through coaching and goal management.

Before describing several features and advantages of the invention in greater detail, various actors involved with the system will first be defined with reference to FIG. 1A: (1) Account manager (device 20)—head of customer service programs and preferably has end to end view of the activities taking place at other user levels (except the client level); (2) Team Manager (device 30)—supervisor of agent team and preferably is able to have end to end view of activities for his or her team of agents; (3) Agent (device 40)—customer service representative (CSR) whose performance will be monitored and enhanced, and will be able to gauge their own activities; (4) Coach (device 50)—quality audit consultant that ensures quality standards are met by monitoring and coaching CSRs/agents on quality standards and parameters; and (5) Application Administrator (device 10)—designated representative of a company or entity whose business and product related support is being provided by the system described herein, and can see all activities of the team(s) and the AI powered customer experience intelligence platform (which may also be referred to as “QA.ai platform” herein).

When initially setting up one example of a system implementing the invention, an Application Administrator (or Admin) will be designated for the QA.ai platform. For example, the role of application administrator may be performed by a representative from the company that provides and maintains the system described herein, and will be responsible for setting up and configuring the application for use. The Admin will be prompted to add connectors for the system to collect the required interaction data, possibly from various disparate sources. The Admin will also be prompted to add metrics and quality parameters of interest for the client's business objectives. In one example, connectors may include one or more libraries for the integration of data from, e.g., voice recording platforms, interaction data from omni-channel platforms, customer satisfaction surveys, CRM (Customer Relationship Management) platforms, social media platforms, etc.

The system provides for a full quality audit, which, in one example, includes the ability to analyze and publish audit results for 100% of the calls and chats in any customer service program. The calls and chats are exchanged between customer computing device(s) 60 and agent computing device(s) 40 (refer to FIG. 1A), for example. A business team 12, for example, provides logics for the creation of checks on various quality parameters for each part of the program, and to share past interaction transcripts. An analytics team 14, for example, will set up an analytics engine enabling analysis of the quality parameters. In one example, an analytics team can include an implementation project manager, a business analyst, a data analyst, an integration engineer and a data scientist. The analytics engine may be trained via machine learning with the quality parameters over time and provide audit results on all parameters. The analytics engine, in one example, can connect with a data pipeline to run audits on all transcripts for a full audit. In one example, the data pipeline may be a distributed scheduling and processing engine that is responsible for scheduling gathering the data from various sources using data connectors. Some parameters may be qualitative in nature which will require a training set with regular updates, while other parameters may be quantitative in nature and will be built by the system itself. Some general examples of the quality parameters include friendly and courteous, self-help, greetings, verification, acknowledgment, probe check, leading the way, closing, mishandling, etc. Some additional examples of QA parameters, which may be more specific to a particular client or customer service program than the generic examples listed above, may include misinformation (e.g., was there any false or inaccurate information that was provided by the agent during the call), disclosing sensitive information, creating the brand magic, check ticket history, used all tools and resources to research, used terms and conditions accurately, use of inappropriate words (e.g., profanity, aggressive words, offensive words, etc.), and the like.

In some examples, the system provides for a full business metrics calculation, which includes the ability to analyze and publish results on different business parameters defined by the system. The business team may provide logics for analysis of different business metrics, including but not limited to, CSAT, Resolution, and AHT, and may provide survey data for past feedback by customers. In one example, the business team may include contact center operations leadership, quality auditors, trainers and clients. The analytics team will set up the analytics engine enabling scoring of conversations on various business metrics. The analytics engine will be trained with the business metrics over time and provide audit results on all metrics. The analytics engine can connect with the data pipeline to for example, run audits on all transcripts for 100% audit. Some parameters are qualitative in nature which will require a training set with regular updates. AHT being a quantitative metric may be determined by the system. CSAT and resolution prediction require initial training data (e.g., all call driver data), access to CRM and access to a help tree (and optionally access to call driver data, if available).

In some examples, the system further provides fully automated insights which includes the ability to publish reports for the program to gain insights via the QA.ai platform. The system will provide business insights in a dashboard (an example graphical user interface (GUI)) that is designed to be easy to operate and interpret. The dashboard may contain reports on performances grouped at the program level (multiple teams), the team level (multiple agents and/or consultants), and the agent/consultant level (individuals).

In some examples, the system also provides coaching compliance and goal management functionality that enables coaching and training management of agents based on QA.ai platform evaluation. Coaching may be provided, e.g., for any quality parameter and/or business metric, and may be provided as part of goals and achievement as well. The system may provide functionality to enable goal creation and management for customer service representatives at the agent level (individuals), the team level (team manager and group of agents) and the program level (all managers and agent teams). Goal results can be monitored, for example, in real time and published by the platform.

In one aspect, the system generates a variety of actionable insights to drive improved consumer care and broader client business by performing near real-time sentiment analysis, call reason analysis, quantifying CSR/agent behaviors most impacting CSAT scores, and identifying consumer insights leading to operational improvements (e.g., labeling, adverse health effect, sustainability, product and geographical views, etc.).

In another aspect, the system also integrates natural language processing (NLP) and AI into the quality monitoring process to enable various features, including but not limited to: robust hands-on case-based training, continuous education, and gamification to ensure team engagement and adherence to quality parameters; immediate time contact trend analysis; analyzing consumer sentiment during a call to provide CSR/agent immediate feedback and recommendations; immediate identification and coaching of bottom performers, and identification of opportunities for mid-performers to improve; and identification of actions that drive improved customer experiences and efficiencies.

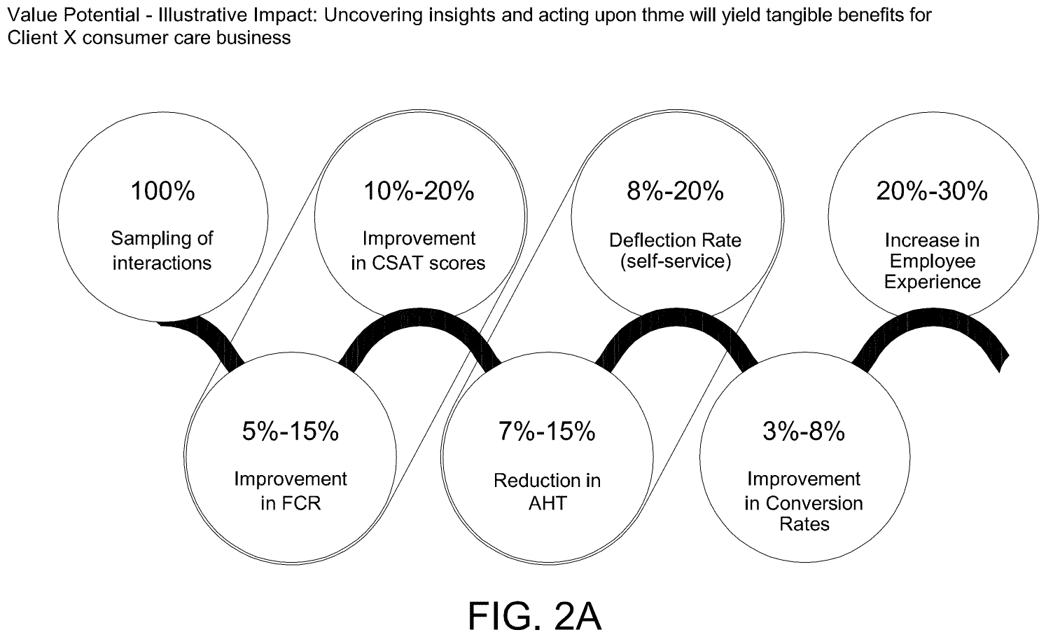

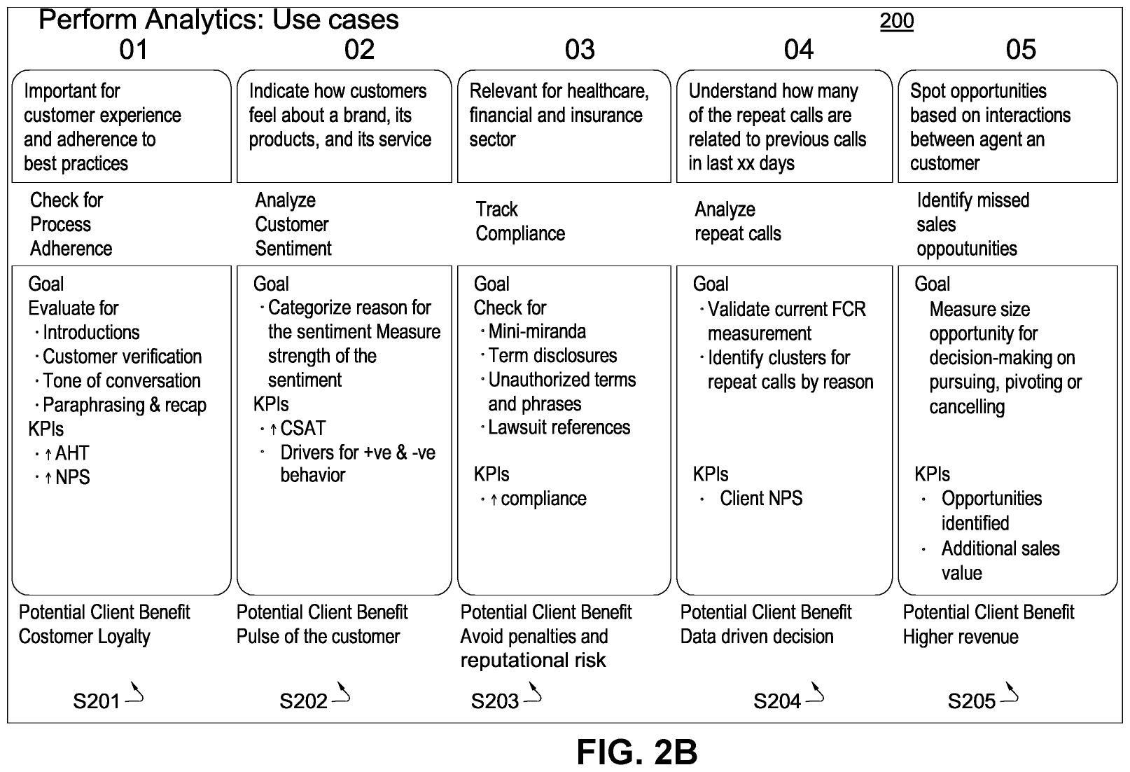

As best seen in FIG. 2A, uncovering insights and acting upon them using the AI/ML based platform described herein has the potential to add significant value for consumer care businesses of clients compared to the prior art, for example: (1) complete sampling of interactions, (2) 5-15% improvement in first call resolution (FCR is a metric that measures a contact center's ability for its agents to resolve a customer's inquiry or problem on the first call), (3) 10-20% improvement in CSAT scores, (4) 7-15% reduction in AHT (average handling time), (5) 8-20% deflection rate (self-service), (6) 3-8% improvement in conversion rates, and (7) up to 20-30% increase in employee experience (e.g., CSRs or agents).

FIG. 2B illustrates several example use cases for Perform Analytics 200 as implemented using the invention described herein. In one instance S201, Perform Analytics can check for process adherence, which is important for customer experience and adherence to best practices. For example, the invention can evaluate for introductions, customer verification, tone of conversation, paraphrasing and recap, and improve KPIs including average handling time (AHT) and net promoter score (NPS). Further, the client can benefit from gaining customer loyalty.

In another instance S202, Perform Analytics can analyze customer sentiment, which indicates how customers feel about a brand, its products, and its services. In one example, the system can categorize the reason for the sentiment, and measure the strength of the sentiment. The system can also improve KPIs such as CSAT scores and identify key drivers and positive and negative behavior. The client can therefore benefit from knowing the pulse of the customer.

In yet another instance S203, the system is configured to track compliance, which is relevant to, for example, healthcare, financial, and insurance sectors. In one example, the system can check for mini-Miranda, term disclosures, unauthorized terms and phrases, and lawsuit references, and improve compliance KPIs. The client can benefit from these features by avoiding penalties and reputational risk.

In another instance S204, the system is configured to analyze repeat calls to understand how many of the repeat calls are related to previous calls in the last x days. For example, the system can validate current first call resolution (FCR) measurement, identify clusters for repeat calls by reason, and improve client NPS KPIs. The client can benefit from this functionality by making data driven decisions.

In still another instance S205, the system is configured to identify missed sales opportunities, which will lead to spotting opportunities based on interactions between CSR/agent and customer. For example, the system can measure the size of the opportunity for decision-making on pursuing, pivoting, or cancelling. KPIs include the opportunities identified, and additional sales value. This functionality benefits the client because it can lead to higher revenues.

In one example use case, customer experience insights for a streaming service provider uncovered opportunities across digitization, pricing and packaging, and technology integration. The system can enable contact deflection (opportunity to deflect over 19% of contact volume), by deflecting “easy” tasks with AI-bots, frequently asked questions (FAQs), and changes to the digital experience. Examples include membership status checks (10%), email change (6%), password change (2%), and general questions on device settings or compatibility (1.3%). The system can provide seamless upgrades, making it easier to make changes. For example, a customer switching to a yearly subscription (5% of contacts) requires revocation of the old (e.g., monthly) subscription and activating a new annual subscription. The system can make this a digital only experience along with mapping and testing of changes/activation/billing. The system can improve product integration, and address technology issues early on. For example, low CSAT scores (59% and 31% resolution) and cancellations due to challenges with external multimedia components for streaming services (e.g., FIRESTICK TV, ANDROID TV, etc.). Addressing such issues via early engagement with the product teams, and quantification of the churn impact overall, may reduce or prevent negative sentiment and churn.

In another example use case, MSAT [WHAT DOES “MSAT” MEAN?] for a telecommunications company was averaging at 4.0 for more than 6 months against a target of 4.25 (4.4 to achieve bonus payment), while resolution was trending at 67%. With the intelligent AI-enabled Quality Audit (QA.ai) platform implemented to ensure 100% audit coverage, near real-time audit score availability, customer sentiment analytics, and actionable insights to the operations team to design and deploy execution plans to improve the performance, MSAT scores improved to an average of 4.37 while resolution improved to about 75%.

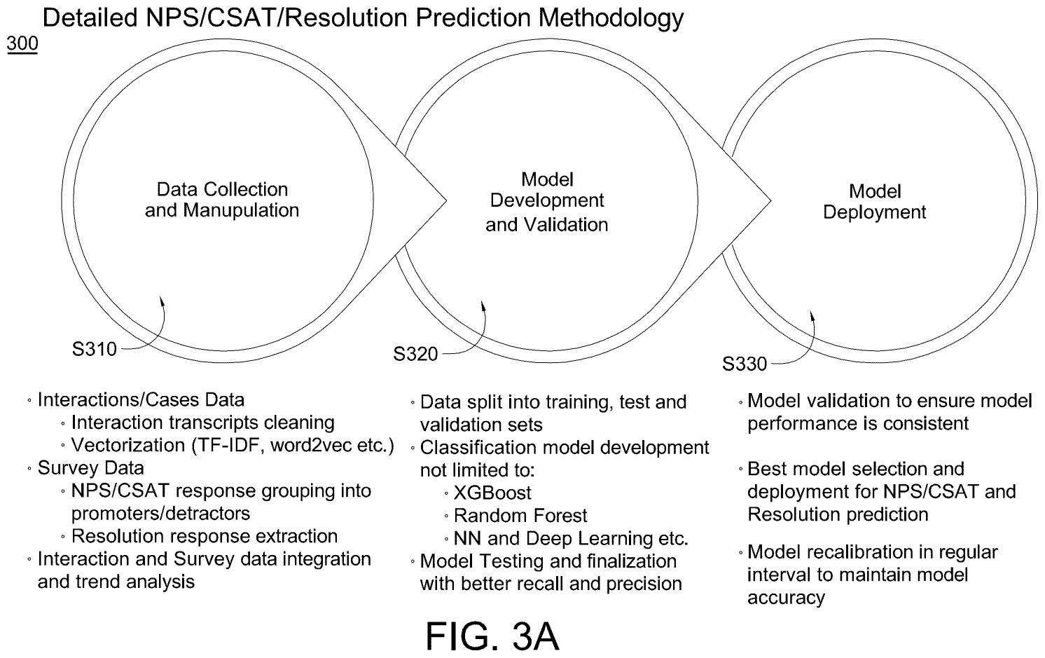

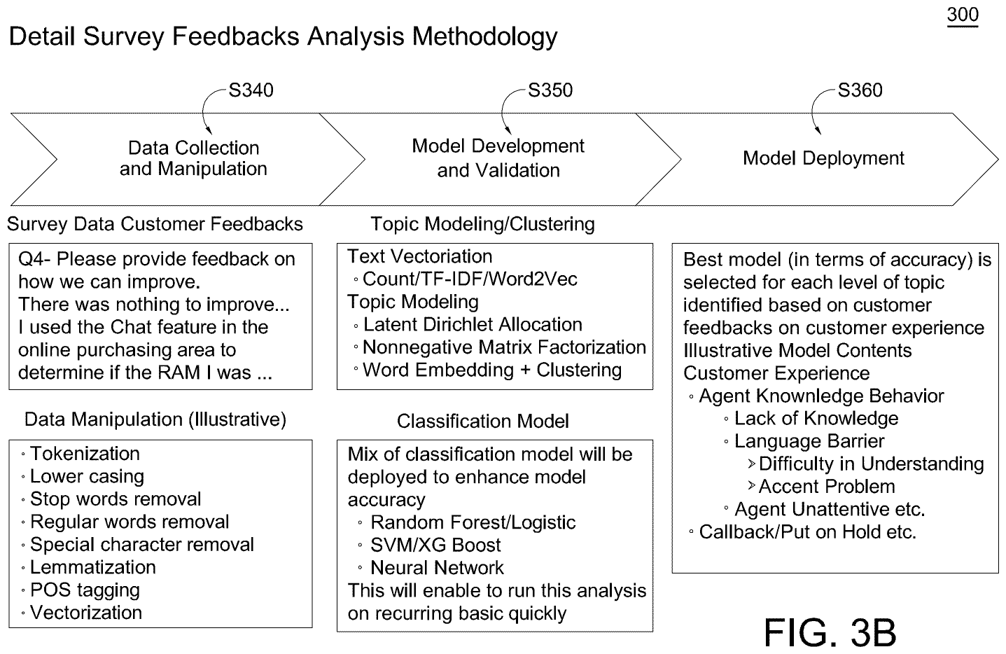

Next, a detailed example NPS/CSAT/Resolution prediction methodology for training machine learning models will be described with reference to FIG. 3A, which includes three phases: (1) data collection and manipulation, (2) model development and validation, and (3) model deployment:

The first phase S310 involves the collection and manipulation of interactions/cases data and survey data. This may include features such as interactions transcripts cleaning, vectorization (e.g., using TF-IDF (Term Frequency Inverse Document Frequency), word2vec, etc.), NPS/CSAT response grouping into promoters/detractors, and resolution response extraction. The interaction and survey data is then integrated and a trend analysis can be performed.

The second phase S320 involves splitting the interactions and survey data into training, test, and validation sets for classification model development, including but not limited to, a distributed gradient-boosting library (e.g., XGBOOST) Random Forest, neural network (NN) and deep learning, etc. Then model testing and finalization can be performed with better recall and precision.

The third phase S330 involves model validation to ensure model performance is consistent, and the selection and deployment of the best model for NPS/CSAT and Resolution prediction. This model can be recalibrated at regular intervals to maintain model accuracy.

Next, a detailed example survey feedbacks analysis methodology for training machine learning models will be described with reference to FIG. 3B, which also includes three phrases similar to the methodology described with respect to FIG. 3A:

The first phase S340 involves collecting survey data customer feedbacks (e.g., customer response to a survey question asking the customer to provide feedback on how the company can improve its brand, products, or services), and manipulating the collected survey data using various data processing techniques (such as tokenization, lower casing, stop words removal, regular words removal, special character removal, lemmatization, parts of speech tagging, and vectorization).

The second phase S350 involves topic modeling/clustering and classification model generation. The topic modeling/clustering step may include text vectorization (e.g., Count, TF-IDF, Word2Vec) and topic modeling (e.g., latent dirichlet allocation, nonnegative matrix factorization, and word embeddings plus clustering. A mix of classification models can be deployed to enhance model accuracy, such as Random Forest/Logistic, SVM/XGBOOST, and NN. This will also enable the system to run this analysis on a recurring basis quickly.

The third phase S360 involves the selection of the best model (in terms of accuracy) for each level of topic identified based on customer feedbacks on the customer experience. Here, an example model outputs various insights related to the customer experience and the agent's knowledge/behavior (e.g., lack of knowledge, language barrier or accent problem, unattentiveness, callback/put on hold, etc.).

With the machine learning models having been trained for NPS/CSAT/Resolution prediction and for survey feedbacks analysis, for example, these ML models may now be applied to interaction data associated with customer service communications to generate actionable insights and predictive scores, as further described below.

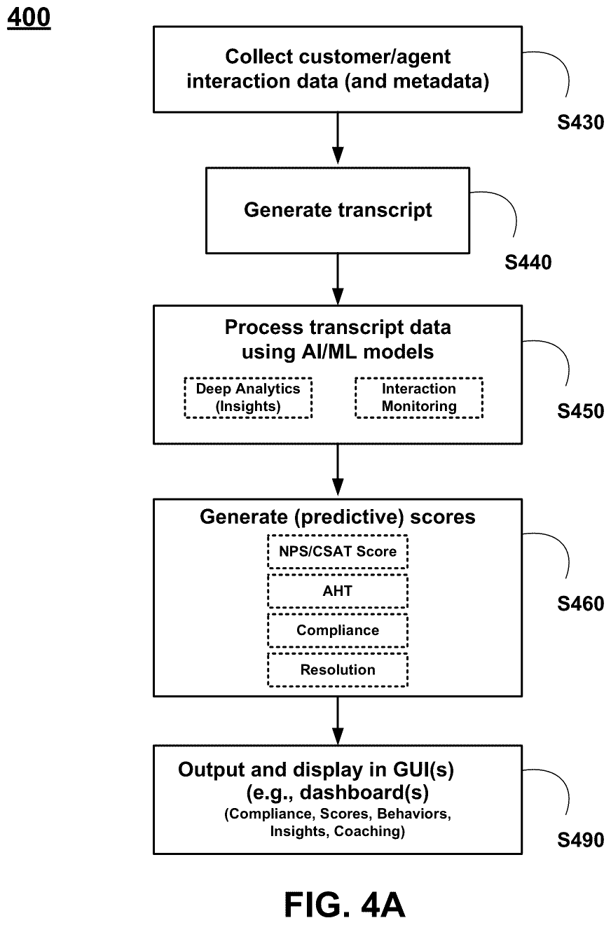

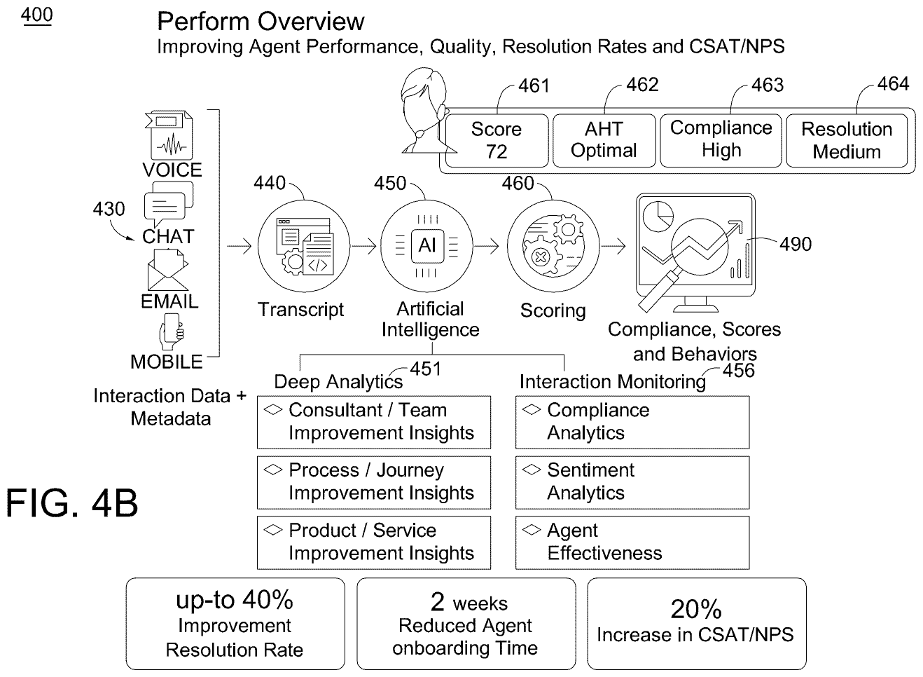

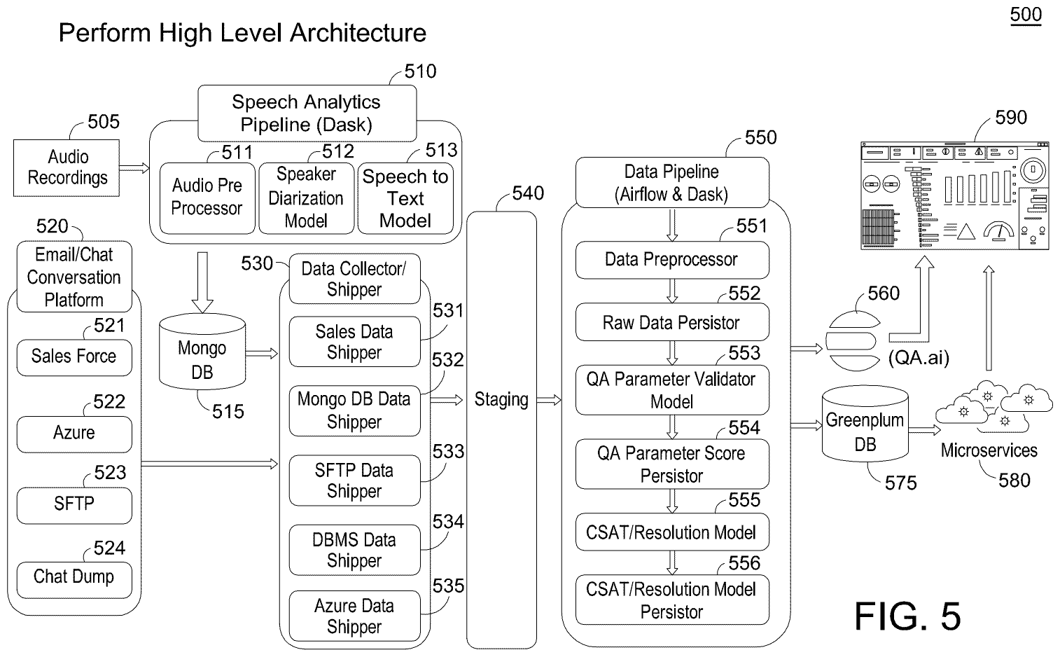

Referring to the method flow chart in FIG. 4A and the corresponding diagram in FIG. 4B, in one aspect of the disclosure, a computer implemented method 400 begins with the collection of interaction data and metadata at step 430. The interaction data and metadata may take various different forms, including but not limited to voice data, chat data, email data, and/or mobile data, as shown in FIG. 4B for example. Further details of obtaining and processing the interaction data from various different sources in connection with this data collection aspect will be described in further detail below with reference to FIG. 5 (e.g., components 510, 520, 530). The interaction data is indicative of agent behaviors during customer service communication exchange, and the metadata may relate to timing (e.g., silence time, customer time, CSR/agent time, etc.) and/or various identifiers (e.g., the CSR/agent, the customer, the session ID itself, etc.), for example. The method 400 also includes generating a transcript based on the interaction data (step 440) and metadata. The transcript is an electronic/digital version of a conversation between an agent and a customer from recorded speech or text, for example.

In another aspect, method 400 further includes applying one or more artificial intelligence and machine learning (AI/ML) models to the transcript at step 450. It should be understood that the one or more AI/ML models are computer executable instructions. More specifically, applying the AI/ML models may include performing deep analytics at step 451 (in FIG. 4B) and performing automated interaction monitoring at step 456 to generate one or more actionable insights related to the interaction. Performing deep analytics 451 may include one or more of CSR/agent or team improvement insights 452, process or journey improvement insights 453, and/or product or service improvement insights 454, for example. Performing automated interaction monitoring 456 may include one or more of compliance analytics 457, sentiment analytics 458, and/or agent effectiveness 459, for example.

In another aspect, method 400 includes generating scores or ratings for agent behaviors based on the results of applying the AI/ML models to the collected interaction data in the transcript at step 460. The scores or ratings may relate to a Customer Satisfaction (CSAT) score or a Net Promoter Score (NPS), Average Handling Time (AHT), compliance, and/or resolution throughout the course of the customer service communication exchange, for example.

In a further aspect, method 400 includes displaying a graphical user interface (GUI) screen including a dashboard showing the generated predictive scores or ratings for the agent behaviors during the customer service communication exchange at step 490. For example, the dashboard may be displayed on a GUI screen of an account manager computing device 20, a team manager computing device 30, an agent computing device 40, and/or a coach computing device 50 (refer to FIG. 1A). The dashboard may display various different information depending on which user (among the managers, coaches, and/or agents) is operating the respective computing device. The dashboard shown on the GUI screen may include, but is not limited to, a CSAT score or NPS score (e.g., scale of 1-100, percentage, or value from −1 to +1), an AHT score (e.g., hrs:mins:secs), a Compliance rating (e.g., high/medium/low or percentage), and/or a Resolution rating (e.g., high/medium/low, percentage, or yes/no where yes indicates the case was resolved and no indicates the case remains unresolved). In some example embodiments, the numeric range for CSAT/NPS scores is −1 to +1 (where −1 indicates strongly negative, +1 indicates strongly positive, and 0 indicates neutral. Positive and negative CSAT/NPS scores can also be identified based on threshold values. The compliance rating is based on the percentage of compliance for the interactions scored, and the ranges for “high” and “medium” and “low” are based on threshold values set forth by the clients (e.g., a compliance score of 75% and above may be considered “high”), and may be customized and updated as desired. The dashboard may also display the one or more actionable insights related to the interaction that are generated using the AI/ML models. These interaction insights may then be acted on by the users of the system, such as account managers, team managers, coaches, and/or the customer service agents themselves, to provide clients with the advantages described herein for improving the overall customer experience.

FIG. 5 illustrates one example of a high level architecture of a system 500 that may be utilized to implement method 400 described above with reference to FIGS. 4A and 4B. The above description of system 1 and system 100 with reference to FIGS. 1A and 1B also applies to system 500. In further detail, system 500 may include a speech analytics pipeline 510 (e.g., DASK), an email/chat conversation platform 520, a data collector/shipper 530, a data pipeline 550 (e.g., AIRFLOW and/or DASK), an analytics and scoring engine 560, and a dashboard 590. As one skilled in the art will know, DASK (Dansk Aritmetisk Sekvens Kalculator or Danish Arithmetic Sequence Calculator) is a flexible open-source parallel computing library for analytics.

The speech analytics pipeline 510 may include an audio pre-processor 511, a speaker diarization model 512, and a speech to text model 513. Audio recordings 505 are input to the speech analytics pipeline 510, and results of the speech analytics performed using components 511, 512, 513 are output to data collector/shipper 530. In some example embodiments, the output speech analytics results may be stored in a database 515 (e.g., a MONGO DB) and made available to data collector/shipper 530 for retrieval. The speech analytics pipeline 510 may be implemented using DASK, for example, or other known or future developed equivalents.

The email/chat conversation platform 520 may include various components including but not limited to Sales Force 521, Azure 522, Secure File Transfer Protocol (SFTP) 523, and Chat Dump 524. The email/chat conversation platform 520 can also provide various interaction data to the data collector/shipper 530 from one or more of these components 521, 522, 523, 524.

The data collector/shipper 530 may include various components associated with the processed audio recordings from the speech analytics pipeline 510 and the email/chat conversations from email/chat conversation platform 520, including but not limited to a sales data shipper 531, a database (e.g., Mongo DB) data shipper 532, an SFTP data shipper 533, a database management system (DBMS) data shipper 534, and a data shipper 535 (e.g., a cloud computing service such as AZURE). The data collector/shipper facilitates the transfer of interaction data from the client to the system (e.g., data pipeline 550 and analytics and scoring engine 560) at regular intervals.

System 500 may further include a staging layer 540, which can be implemented using multiple technologies including but not limited to a data storage repository. The staging layer 540 contains raw data from interactions, cases, survey etc., that were for each interaction between an agent and a customer from the interaction data that is output from the data collector/shipper 530.

However, the interaction data from the data collector/shipper 530, which is arranged into a transcript by staging layer 540, may include a large amount of raw data. Therefore, the transcript including the interaction data may be sent to data pipeline 550 for further processing of the raw data to transform it into more digestable and analyzable data.

Data pipeline 550 may include various components for processing the raw interaction data included in the transcript, including but not limited to, a data pre-processor 551, a raw data persistor 552, a QA parameter validator model 553, a QA parameter score persistor 554, a CSAT/Resolution model 555, and a CSAT/Resolution model persistor 556. Data pre-processor 551 brings the data from the staging area in and prepares the data for inference by AI/ML models upstream. Raw data persistor 552 prepares the data to be persisted in a relational database (including the extraction of data from unstructured data, column aggregation, etc.). QA parameter validator model 553 is an AI/ML inference process where the models are used for automatic scoring of QA parameters that are configured for the program. QA parameter score persistor 554 scores the interaction based on the QA parameters and prepares the data to be persisted into the relational database. CSAT/Resolution model 555 is an AI/ML model that predicts the probability of the resolution of the case based on the case data and the interactions data. CSAT/Resolution model persistor 556 is an AI/ML model that predicts the potential rating by a customer if the interaction was surveyed. Data pipeline 550 may be implemented using AIRFLOW and/or DASK, for example, or other known or future developed equivalents.

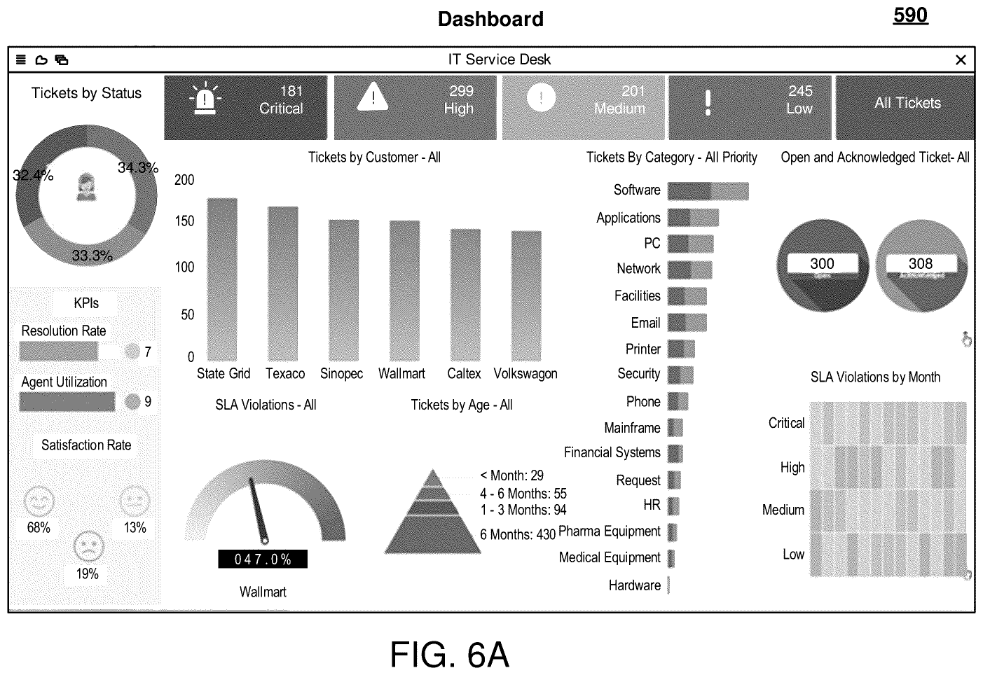

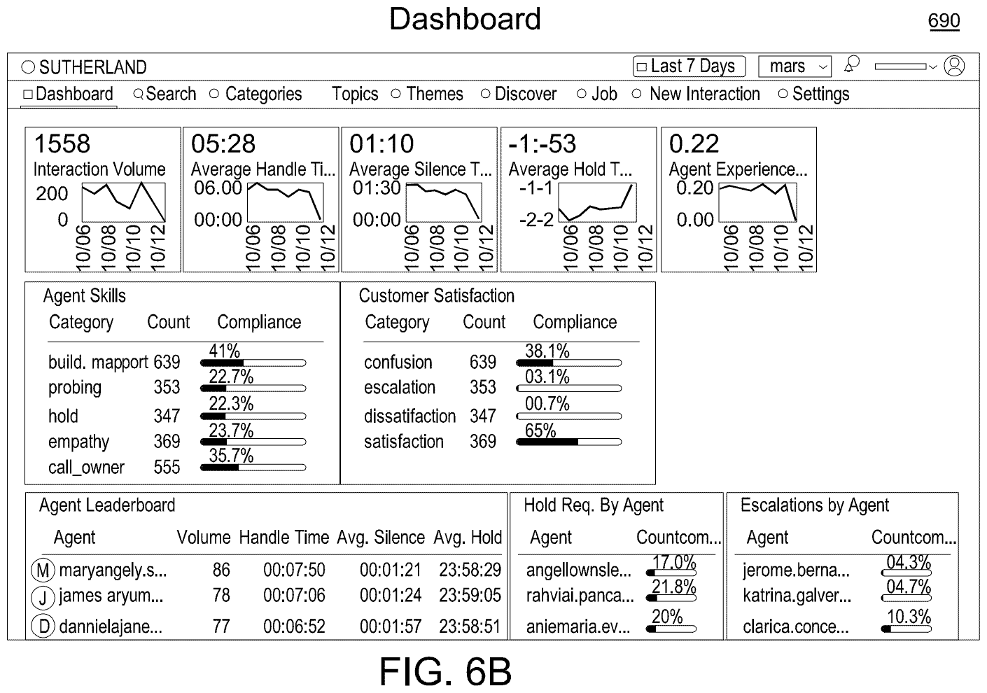

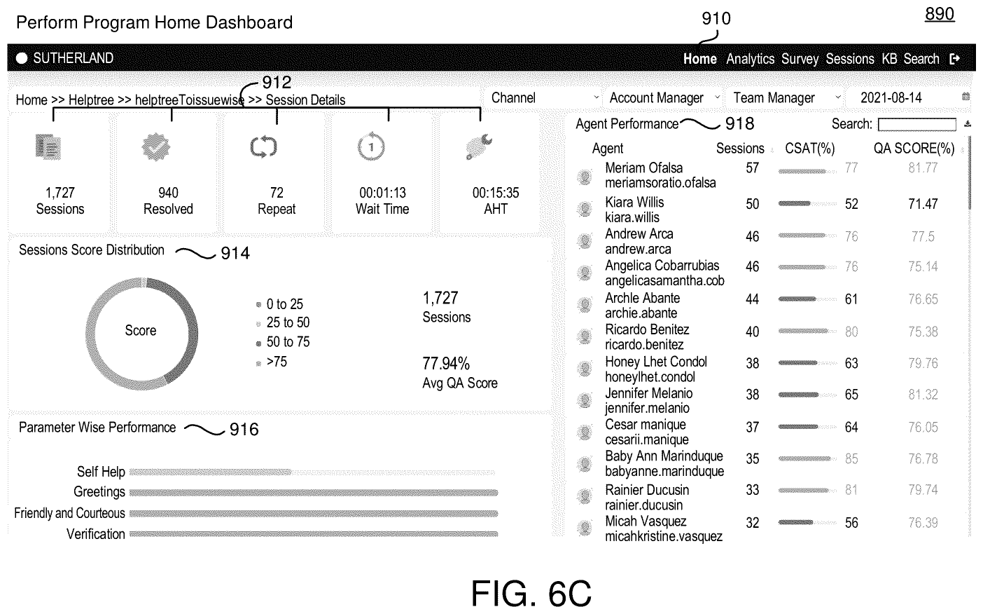

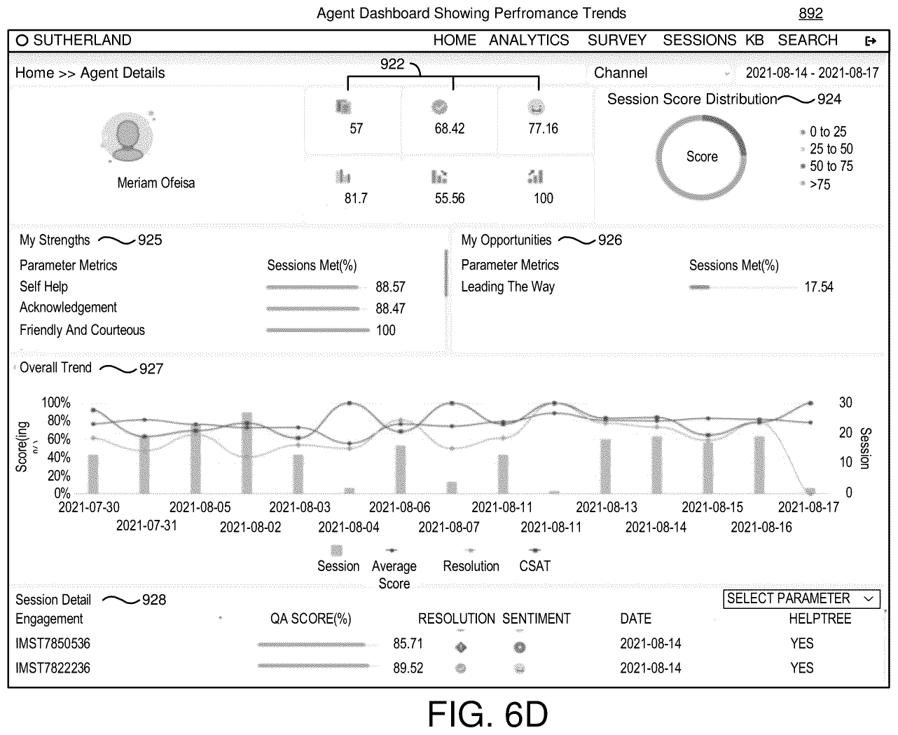

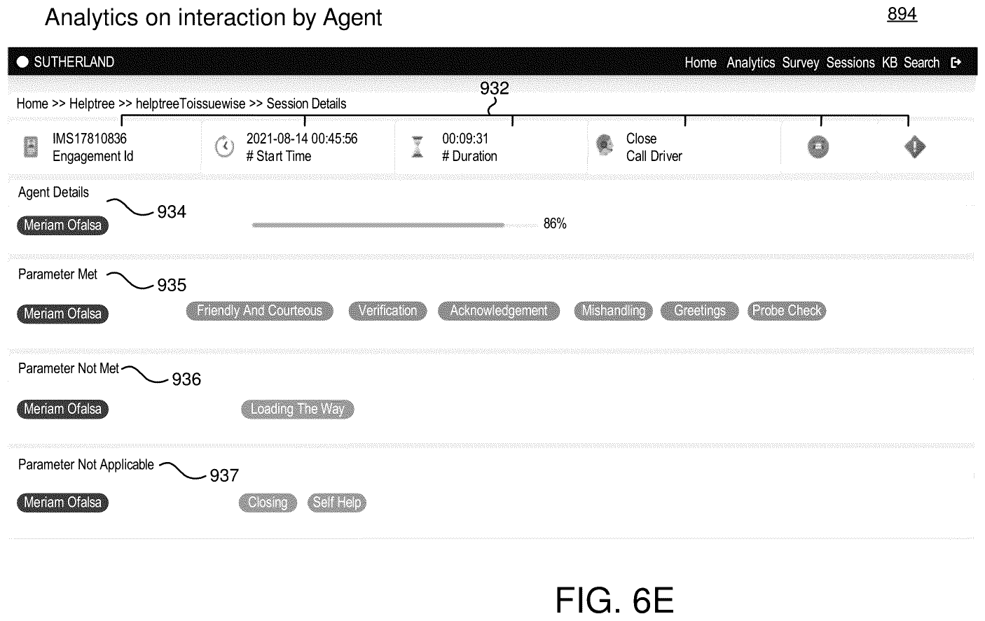

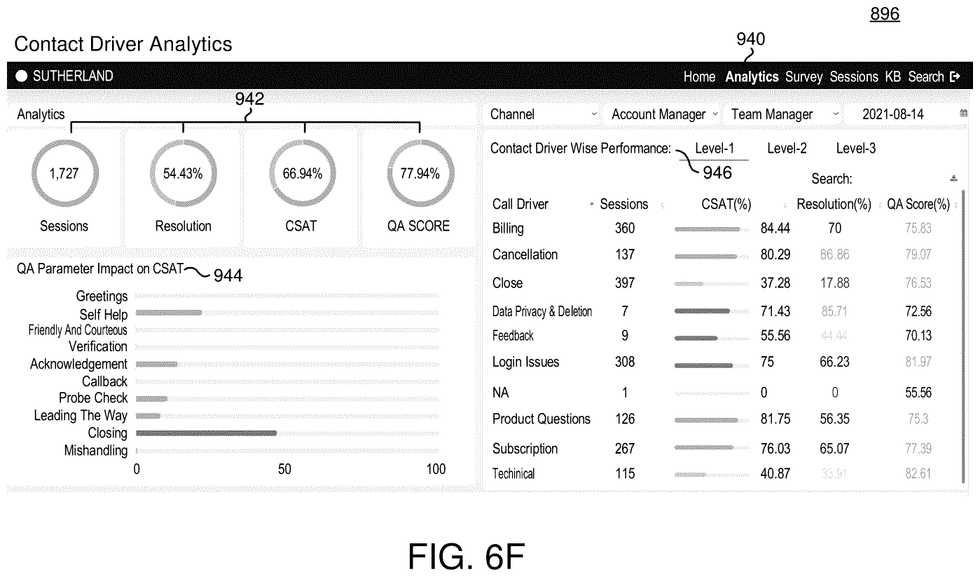

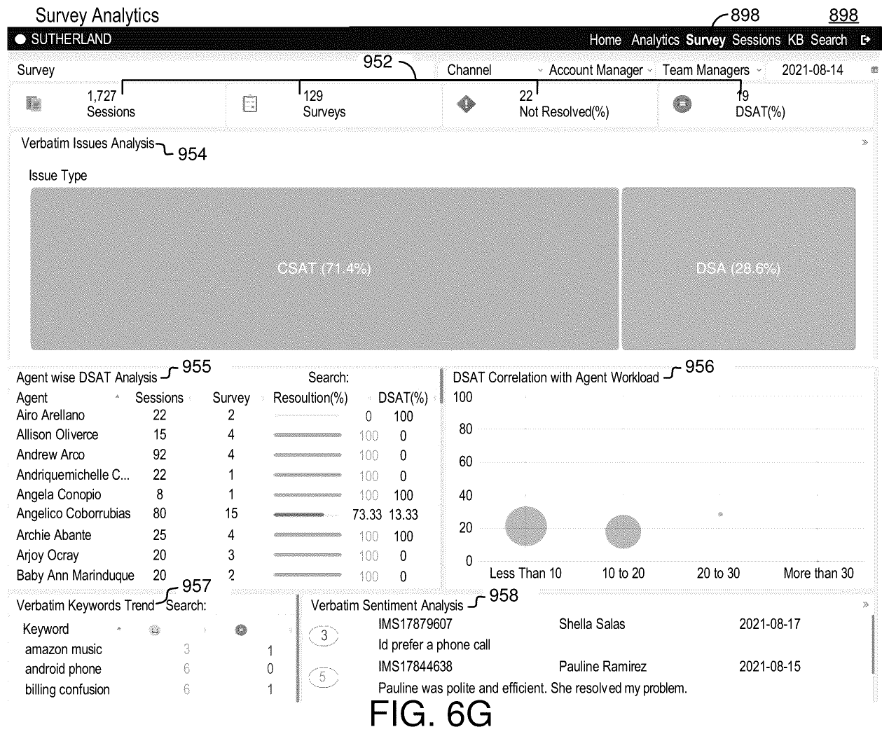

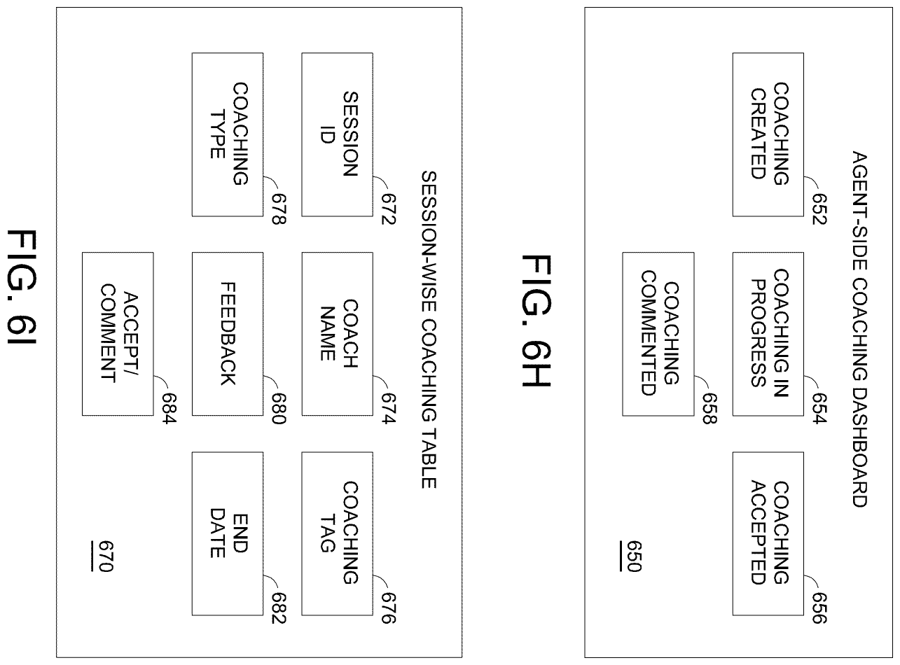

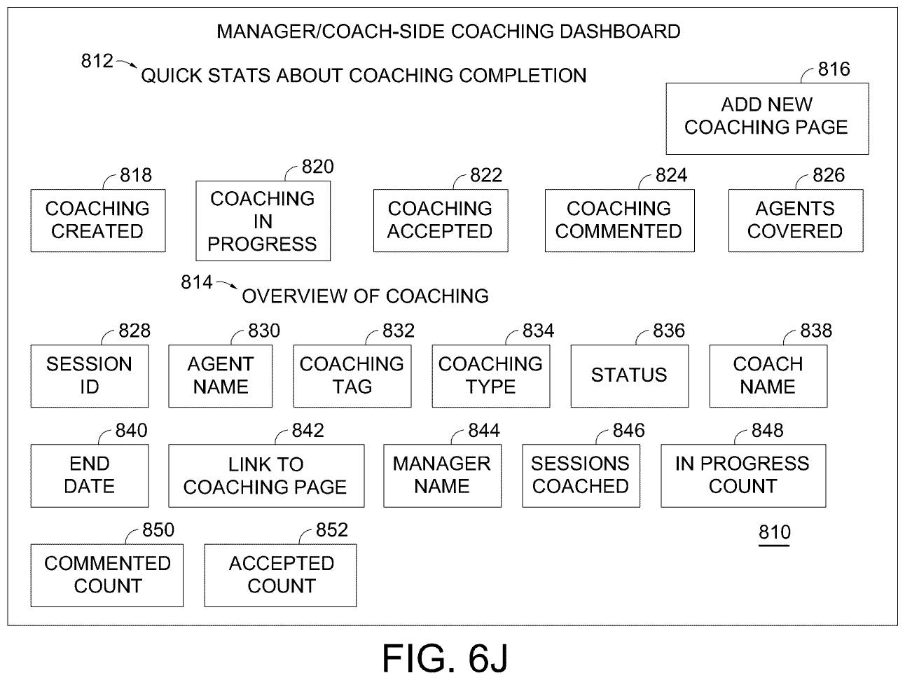

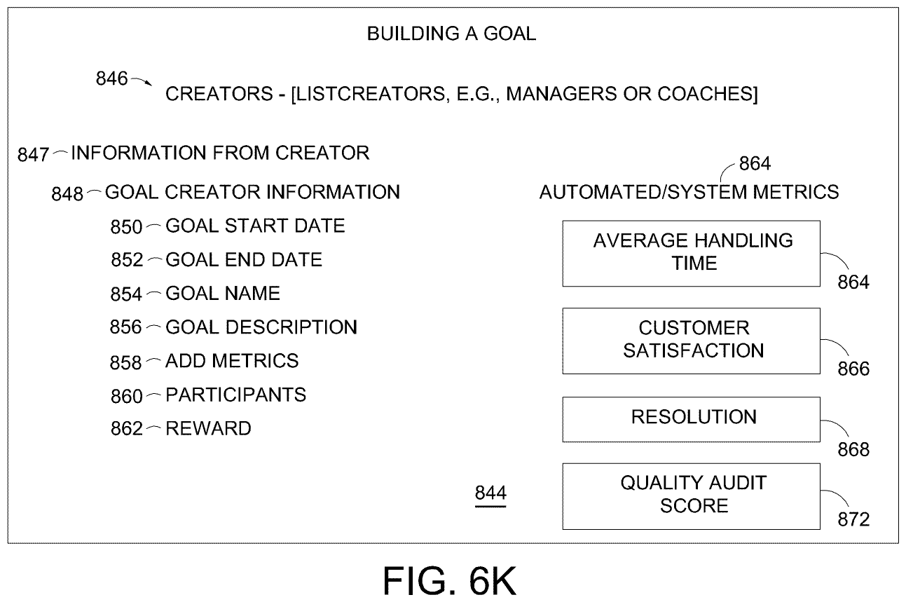

The data output from data pipeline 550 may then be sent to analytics and scoring engine 560 for further processing. For example, analytics and scoring engine 560 can run one or more machine learning models on the transcript that is output from staging module 540 to generate a predictive outcome for each interaction, and save resulting data in a database for publishing metrics on user dashboard 590. An analytics and scoring engine 560 finally determines if the necessary process, language, and other quality metrics as defined for the program are met during the evaluation of the case interaction by the various AI/ML models utilized in Perform Analytics. Each of the QA parameters is given a weight and the sum total of the weighted QA parameters will be on a scale from 1 to 100 (or a percentage) with a full score being equal to 100. There may also be certain QA parameters, called “fatal” parameters, which must be met for the automated AI/ML audit to pass. Apart from the QA parameters, the predictive CSAT and predictive resolutions give operational insights that will help in improvement of customer satisfaction and case resolution. While the scoring and its rules are configured, the final score is dependent on AI/ML inference on the individual QA parameters. The results from the interactions and the scoring are used to improve operational efficiency, customer satisfaction, increased sales, etc. for the program. Additionally, the Perform Analytics dashboards also give insights on the following: (1) top contact drivers (inferred by using a AI/ML model using a topic modeling technique, for example) and its performance on resolution rates, CSAT scores and the QA parameters collinearity with the resolution and CSAT (see FIG. 6F); (2) dashboards showing insights on teams performance scores (scores may include overall quality scores, insights by QA parameters, AHT, silence time, insights by agents, etc.) (see FIGS. 6D, 6E, 6F); and (3) analytics on survey responses, including factors that improve CSAT and factors that contribute to DSAT, verbatim analytics and topics that are ??? [WHAT IS THE REST OF THE PHRASE?] (see FIG. 6G).

In some example embodiments, the data output from data pipeline 550 may be stored in a database 575 (e.g., a Greenblum DB), and made available to one or more microservices 580 for retrieval, which are configured to manage and provide access to the data pipeline-processed data. Microservices 580 is implemented by middleware that is used for all communication by the web application to connect to all backend services, such as authentication & authorization, pulling data and insights, passing data to backend services to persist data, etc. All of the data for the dashboards and reports are delivered by microservices 580, and the web application leverages microservices 580 to get data for the dashboards and reports. Some other services that may be provided by microservices 580 in addition to those mentioned above include: capability to edit QA scores on exception basis by QA auditors, coaching feedback from coaches and team leaders/managers to agents to improve the performance, workflow to acknowledge or reject the coaching feedback by the agents, and performance improvement plans for agents based on the historical performance, etc. Data processed by microservices 580 (e.g., published metrics) may also be shown on dashboard 590, in addition to analytics and scoring engine 560 processed data. Dashboard 590 is an identity and access-managed user dashboard for reading program results and (TEXT MISSING ON PAGE 3 OF SGS PERFORM “BUSINESS REQUIREMENTS” DOCUMENT).

An example dashboard 590 is best shown in FIG. 6A, which corresponds to step 490 of FIGS. 4A-4B and is an enlarged version of dashboard 590 of FIG. 5. Another example dashboard 690 is shown in FIG. 6B, which includes various charts (e.g., Interaction Volume, Average Handling Time, Average Silence Time, Average Hold Time, Agent Experience Indicator, etc.) and tables (e.g., Agent Skills, Customer Satisfaction, Agent Leaderboard, Hold Requested By Agent, Escalations by Agent, etc.) including compliance scores for agents in different categories. For example, categories in the “agent skills” table may include build rapport, probing, hold, empathy, call ownership, etc., while categories in the “customer satisfaction” table may include confusion, escalation, dissatisfaction, satisfaction, etc., as shown in FIG. 6B.

An example “Home” dashboard 890 for the Perform Analytics program is shown in FIG. 6C, which may be displayed when a user initially accesses the Perform program or upon a user selecting the “Home” tab 910 shown in the upper right corner. The home dashboard 890 may indicate various program analytics data 912 such as the total number of sessions, the number of sessions resolved, the number of repeated sessions, wait time, and AHT. A “session score distribution” section 914 may include a graph broken down into scoring tiers (e.g., 0-25, 25-50, 50-75, 75-100) and an average QA score. A “parameter wise performance” section 916 may indicate ratings for various QA parameters (e.g., self help, greetings, friendly and courteous, verification, etc.). An “agent performance” section 918 lists all of the agents along with their number of sessions, CSAT (%), and QA score (%).

FIG. 6D shows an example “Agent Details” dashboard 892 illustrating performance trends for an agent. The agent details dashboard 892 may be displayed in response to a user selecting a particular agent in the “agent performance” section of FIG. 6C, for example. The agent details dashboard 892 may identify the individual agent and indicate various individual analytics data 922 such as the total number of sessions, resolution (%), CSAT (%), average QA score, minimum QA score and maximum QA score, along with a session score distribution 924 for the individual agent. In addition, the agent details dashboard 892 may identify one or more strengths 925 of the agent (e.g., self-help, acknowledgment, friendly and courteous) and one or more opportunities for improvement 926 by the agent (e.g., leading the way) based on the number of sessions met (%) for different parameter metrics. An “overall trend” graph 927 illustrates average score, resolution, CSAT score (in %) for each session over an extended period of time for the particular agent, and a “session detail” section 928 identifies each session by engagement ID and indicators relating to QA score (%), resolution, and sentiment.

FIG. 6E depicts an example “Analytics on Interaction by Agent” dashboard 894. Dashboard 894 may be displayed in response to a user selecting a particular session identified in the “session detail” section of FIG. 6D, for example. The session details dashboard 894 may include session details data 932 (e.g., engagement ID, start time/date, duration, call driver, sentiment, and resolution), agent details 934 (e.g., CSAT and/or QA score), parameter met 935 (e.g., friendly and courteous, verification, acknowledgment, mishandling, greetings, probe check), parameter not met 936 (e.g., leading the way), parameter not applicable 937 (e.g., closing, self help).

An example “Analytics” dashboard 896 showing contact driver analytics is shown in FIG. 6F, and may be displayed in response to a user selecting the “Analytics” tab 940 shown in the upper right corner. The analytics dashboard 896 may indicate various scoring analytics data 942 (e.g., number of Sessions, Resolution, CSAT, and QA Score), as well as a “QA Parameter Impact on CSAT” section 944 showing the degree to which various QA parameters (e.g., greetings, self help, friendly and courteous, verification, acknowledgment, callback, probe check, leading the way, closing, mishandling, etc.) affected the CSAT score. A “contact driver wise performance” section 946 lists various call drivers (e.g., billing, cancellation, close, data privacy & deletion, feedback, login issues, product questions, subscription, technical, NA, etc.) along with a number of sessions, CSAT (%), resolution (%), and QA score (%) corresponding to each call driver, respectively.

An example “Survey” dashboard 898 showing survey analytics is shown in FIG. 6G, and may be displayed in response to a user selecting the “Survey” tab 950 shown in the upper right corner. The survey dashboard 898 may include various survey analytics data 952 (e.g., number of sessions, number of surveys, number of sessions not resolved (%), and DSAT (%)), a verbatim issues analysis section 954 showing an issue type graph (e.g., CSAT vs. DSAT), an agent-wise DSAT analysis section 955 (listing agents, number of sessions, number of surveys, resolution (%), and DSAT (%)), a DSAT correlation with agent workload section 956, a verbatim keywords trend section 957, and a verbatim sentiment analysis section 958. [ANY ADDITIONAL DESCRIPTION TO ADD FOR FIGS. 6C-6F RELATING TO NEW DASHBOARD SCREENSHOTS?].

However, it should be understood that the dashboards shown in FIGS. 6A-6G are intended to be examples only and non-limiting in nature, and various types of information and formats for presenting data and results may be utilized in the dashboard design depending on the client and any unique configurations.

In addition to dashboards 590, 690 and 890/892/894/896/898 displaying the system-generated interaction insights and published metrics, various other dashboards can also be used to implement the coaching and goal management features for the program, which are described in further detail below. [Are there any drawings, images, slides, dashboards, GUI screens, etc. available that are associated with the “Coaching” and “Goal Management” features described in the SGS “business requirements” document and are summarized in the following paragraphs [0077]-[0097] below? If these are unavailable or otherwise difficult to prepare, we can proceed without them and use only the new dashboard drawings in FIGS. 6C-6F as described above].

As described above, system 1 in FIG. 1A (also refer to systems 100 (FIG. 11B) and 500 (FIG. 5)) allows account managers, team managers, and coaches to see the results of an agent's actions across each session and coach them on their shortcomings. The goal management feature will allow the team managers and coaches to identify common mistakes made by the agents, and coach them by providing feedback and directions for future improvements. The goal is to promote healthy discussion between agents and coaches at all times, hence agents and coaches can also discuss and comment on the coaching feedback initiated on any session by the coach.

System 1 allows for the creation of a coaching tag that will help account managers, team managers, and coaches to create tags against every session, and coach agents on the mistakes they are making in their interactions with the customers, using their respective computing devices. The system allows account managers, team managers, and coaches to read through the session details and understand the type of coaching the agent needs, tag the session so that one tag can be used for similar mistakes the agent makes in different sessions, and provide feedback for all the sessions with the same tag at once which will be reflected for the agent.

System 1 further provides a coaching feedback creation feature that allows the coaches to add their feedback against various sessions that the coach has tagged. The coach will select a tag against which the feedback will be created (e.g., via a drop down menu from which coaches can select the tags that were created by them), and select a coaching type to give a direction to agents (i.e., which KPI this coaching is trying to address). The coaching types displayed for selection may include quality parameter coaching, handling time coaching, CSAT coaching, and resolution coaching, for example. The coach can set a specific end date for the coaching, or a default such as five or more days from the date of creation may be preset, for example. The coach can then enter their feedback to explain the mistake and how the same can be rectified by the agent in the future, and submit the feedback to the system for review by the agent. Once the coaching feedback has been generated, it will be reflected on the agent's coaching dashboard as well.

Different dashboards will be shown to agents and account managers/team managers/coaches, respectively, so that they can relate to their sessions and act accordingly.

FIGS. 6H-6K are simplified examples of additional GUI content fields, in accordance with one or more aspects of the present invention. These simplified examples can be turned into GUI screens similar to FIGS. 6A-6G, including, for example, various types of graphs, pie charts, buttons and other types of links leading to more detailed information for relevant topics.

An agent-side coaching dashboard 650 shown in FIG. 6H may include, for example, information for agents organized in tables and/or tabs. The following example information may be shown in the agent-side coaching dashboard: (1) Coaching Created 652 (number of sessions tagged between the selected dates for that agent), (2) Coaching In Progress 654 (number of coaching with “in-progress” status, i.e., no action taken by agent yet), (3) Coaching Accepted 656 (number of accepted coaching created in those dates), and (4) Coaching Commented 658 (number of declined coaching).

In a session-wise coaching table 670 shown in FIG. 6I, for example, the agent may be shown coaching against each session that agent was part of, with a link to that session in order to read the chat log and decide to acknowledge and close the coaching, or decline and comment on the coaching. Fields in such a session-wise coaching table may include, for example, Session ID 672 (number of sessions that were coached), Coach Name 674, Coaching Tag 676, Coaching Type 678, Feedback 680, End Date 682, and Accept/Comment the coaching 684. In one example of Accepts/Comments the coaching, if the user accepts the coaching then the coaching will be marked as complete and next time user sees this session it will be shown as coaching completed. Acceptance will be done after double checking if the user chooses to comment the user will be shown the pop up with, for example, mandatory information that needs to be filled in may include commenting (e.g. 200 words max) to describe the issue found in the feedback with a submit button for submission.

In another example, a tag-wise coaching table, may be available. The agent may be shown, for example, coaching against every tag that was created for this agent by the coach, to give a grouped feedback so that the agent can quickly glance through various feedbacks and teachings that the coach wants to highlight and close the loop. The tag-wise coaching table may be similar as above, but instead of a Session ID field there may be a Sessions Included field, along with a link to a Sessions page where, for example, all of the sessions that are marked with the current Tag may be shown.

In still another example, a manager/coach-side coaching dashboard 810, may contain information for coaches, team managers, or account managers divided in, for example, two sections—Quick Stats about Coaching Completion 812 and Overview of Coaching 814.

In one example, the Quick Stats about Coaching Completion section 812 may show important metrics regarding the completion and current status of coaching activity for the program for a particular time frame (e.g., one month, etc.). Such a section may also include, for example, a link or button 816 for navigating the coach to the add new coaching page within. Fields in the Quick Stats about Coaching Completion section may include, for example, Coaching Created 818 (number of sessions tagged between the selected dates), Coaching In Progress 820 (number of coaching with “in-progress” status, i.e., no action taken by agent yet), Coaching Accepted 822 (number of accepted coaching created in those dates), Coaching Commented 824 (number of declined coaching), and Agents Covered 826 (number of agents covered in these coaching created).

In one example of the Overview of Coaching section 814, the overview by sessions may provide, for example, a view of session-wise coaching completed for the agents, which may be filtered according to various users (e.g., agents, coaches). Fields in the table may include, for example, Session ID 828, Agent Name 830, Coaching Tag 832, Coaching Type 834, Status 836, Coach Name 838, End Date 840, and Link 842 to the coaching page (showing feedback and all other fields). The Status field 836 may be one of, for example, In Progress (signifying no further action taken by agent yet), Commented (signifying comments are being discussed between agent and coach), or Accepted (signifying agent has acknowledged and accepted the coaching for the session).

In one example of the Overview of Coaching section 814, the overview by agent may provide, for example, an overview of coaching status for each of the agents, which may be filtered according to various users (e.g., agents, managers). Fields in such an Overview of Coaching section may include, for example, Agent Name 830 (with link to agent page), Manager Name 844, Sessions Coached 846 (number of sessions coached out of total number of sessions for this agent), In Progress count 848, Commented count 850, and Accepted count 852.

The Overview of Coaching section may also provide, for example, a discussion via comments. Both the agents and the coaches can use their respective computing devices (e.g., refer to 40 and 50 of FIG. 1A) to comment on the coaching provided, and the comments will be shown on the Sessions page where the agent who initiated the discussion can finalize their coaching. However, in one example, the first comment may only be initiated by the agent using the agent's computing device (40). For example, the agent may not want to acknowledge the feedback provided by the coach, or may want to discuss the feedback with the coach before completing the learning. The first comment may be generated by the agent from the Coaching page in the agent's dashboard (the comment may, for example, be written in the Decline option that was presented to the agent in either the session-wise coaching or the tag-wise coaching described above), and reflected in the Sessions page under a Coaching Comment section.

Once the first comment has been generated by the agent, a Comments section may be added and maintained on the respective Sessions page for which the comment was initiated, so the coach and the agent can both refer to the chat session and then Add Comments into the Coaching Comments section. A Complete button, for example, may allow for the users to accept the coaching and close the commenting option at any stage before the end date of the coaching as well. Such a feature provides an option for agents and coaches to discuss issues with the coaching feedback and close the coaching only when the agent feels that he or she has learned something new from their earlier mistakes.

Coaching can be closed, for example, either by the agent or the coach at any point during the set coaching period using their respective computing devices (e.g., 40 or 50), or will be closed by default once the End Date of the coaching has passed (e.g., minimum 5 day window from the date of coaching creation).

System 1 may also provide a goal management feature that allows account managers, team managers, and coaches to use their respective computing devices (e.g., refer to 20, 30, 50 of FIG. 1A) to track the progress of agents, and may facilitate performance improvement by providing incremental goals, targets, and rewards to the team managers and agents.

In one example, the goal management feature allows team managers and coaches to create periodic goals for their team of agents, and track their progress on selected metrics within the goal period, using their respective computing devices (30 or 50). This feature allows team managers and coaches, for example, to build a goal, select some metrics to be tracked in the goal along with a performance target against each metric, track the agent's performance, coach the agent on weaknesses post-completion, and reward the agent for strengths. Similarly, account managers could use the goal management feature to set, manage, and track progress of goals for team managers and agents using the account manager's computing device (20).

For building a goal 844 (see FIG. 6K), system 1 may require, for example, creators 846 (e.g., managers or coaches) to fill in various information 847 including Goal Creator Information 848, Goal Start Date 850, Goal End Date 852, Goal Name 854, Goal Description (expectations) 856, Add Metrics 858, Participants 860, and Reward 862 (provided to agent upon successful completion of the goal). The manager or coach can select, for example, an Automated/System Metric 864 from among pre-defined options provided to users for tracking (e.g., the system can automatically track and publish results for AHT 866, CSAT 868, Resolution 870, and QA Score 872). The manager or coach may also select a Metric Target Value that the agent needs to achieve in order to win the reward on this goal completion (e.g., based on a one month performance average of agents on various KPIs, for example). The system may track the agent's performance from the start date, a summary of agent performance may be presented on the goal end date for final results, and this goal may then be terminated.

For completing a goal, the goal may end, for example, automatically once the End Date has passed, or, as another example, the goal may end manually via a stop option provided to the users (e.g., managers, agents, coaches) via their respective computing devices (e.g., 20, 30, 40, 50). The stop goal option when used may, for example, stop the further monitoring and recording of goal performance, and may complete the goal for all of the participants involved. In one example, coaches, team managers, and account managers may be given an option to create completion remarks against the completed goals for the agent. Once the coach or manager sees the agent performance on the goal, for example, they may be able to appreciate the agent or provide steps to improve in the future.

In one example, a goal review page may display the existing goal page that was created at the beginning of the goal, along with a manager/coach dashboard and an overview by goals table (fields may include, e.g., Goal Name, End Date, Agent Covered, Metrics Covered, and Review with a link to goal data). The manager/coach dashboard may show, for example, Goal Count (number of goals which had end dates between the selected dates), Agents Covered (number of unique agents covered in all these goals), and Agents Rewarded (number of agents who received the reward).

In one example, a groups feature facilitates intra-program group chats and conversations as well as one-to-one messaging between group members. For example, a group may be created for a specific team, including the team manager and all of the agents that are members of that team. Similarly, a group may be created that only includes agents (no managers or coaches). The “groups” feature may allow, for example, teams or agents to share important updates and/or documents regarding process changes with each other, allow team or agents to discuss important questions among themselves and encourage peer-to-peer learning, provide a section where the agents can collaborate with each other without the supervision of account managers or team managers, and enable one-to-one discussion for collaboration and bonding within the team of agents.

In another example, there may be a general group for all the implementations of the QA.ai platform for multiple distinct clients, where all individuals who are part of the program are connected and they can share and update posts/documents for discussion with everyone in the program. A private group with a limited number of members (a defined list) may be created by the users as well (e.g., a team managers group, a team group, an agents group, a coaches group, combinations thereof, etc.). The posts and activities shown may be limited to that specific group only. Group members may also be allowed to initiate one-to-one conversations between themselves via a chat section on the groups page. Group members, for example, may see a list of all users or most recent users with whom the person has conversed earlier, and search any other group member by name and click on them to start the conversation.

Thus, example embodiments of the system and method described in detail above provide an automated, non-linear quality audit (QA) and monitoring solution which has various advantages over conventional customer service programs, including but not limited to, the ability to provide complete audit coverage, analyze processes for key performance indicators (KPIs), integrate customer relationship management (CRM) systems, speech recordings and chat transcripts, monitor and support CSR/agent performance, and provide unified metrics. Automated monitoring and scoring of CSR/agent compliance and performance helps to improve customer service levels. Other solution highlights include the ability to ingest interaction data from multiple disparate sources (both structured data and unstructured data), provide detailed reports at the CSR/agent level and the team/manager level, predict sentiments, resolution rates and CSAT/NPS scores, and provide continuously updated text analytics AI/ML algorithms, along with a modern user interface and user experience (UI/UX) design for easy navigation.

While an example machine-algorithm method 400 for the example system 1 (as well as systems 100 and 500) has been described above and with reference to the figures above, it will be understood that certain example embodiments may change the order of steps of the algorithmic method or may even eliminate or modify certain steps.

Having described the example systems 1, 100, and 500 and corresponding example method 400 for generating interaction insights among other features, an example computer environment for implementing the described design and execution is presented next.

FIG. 7 shows the components of an example computing environment 700 that may be used to implement any of the methods and processing thus far described. The following description of computers also applies to the various user computing devices (e.g., 10, 20, 30, 40, 50) and the server (70) for implementing systems 1, 100, and 500 as described above. Computing environment 700 may include one or more computers 712 comprising a system bus 724 that couples a video interface 726, network interface 728, a keyboard/mouse interface 734, and a system memory 736 to a Central Processing Unit (CPU) 738. A monitor or display 740 is connected to bus 724 by video interface 726 and provides the user with a graphical user interface to view the dashboard screens (e.g., 590, 690, and/or 890/892/894/896/898 of FIGS. 6A-6G) displaying the scores and interaction insights generated by the system, as well as to provide or receive coaching and exchange comments, as described above. The graphical user interface allows the user to enter commands and information into computer 712 using an interface control that may include a keyboard 741 and a user interface selection device 743, such as a mouse, touch screen, or other pointing device. Keyboard 741 and user interface selection device are connected to bus 724 through keyboard/mouse interface 734. The display 740 and user interface selection device 743 are used in combination to form the graphical user interface which allows the user to implement at least a portion of the present invention. Other peripheral devices may be connected to the remote computer through universal serial bus (USB) drives 745 to transfer information to and from computer 712. For example, cameras and camcorders may be connected to computer 712 through serial port 732 or USB drives 745 so that data representative of a digitally represented still image, video, audio or other digital content may be downloaded to memory 736 or another memory storage device associated with computer 712 such that the digital content may be transmitted to a server (such as server(s) 30, 40) in accordance with the present invention.

The system memory 736 is also connected to bus 724 and may include read only memory (ROM), random access memory (RAM), an operating system 744, a basic input/output system (BIOS) 746, application programs 748 and program data 750. The computer 712 may further include a hard disk drive 752 for reading from and writing to a hard disk, a magnetic disk drive 754 for reading from and writing to a removable magnetic disk (e.g., floppy disk), and an optical disk drive 756 for reading from and writing to a removable optical disk (e.g., CD ROM or other optical media). The computer 712 may also include USB drives 745 and other types of drives for reading from and writing to flash memory devices (e.g., compact flash, memory stick/PRO and DUO, SD card, multimedia card, smart media xD card), and a scanner 758 for scanning items such as still image photographs to be downloaded to computer 512. A hard disk drive interface 752 a, magnetic disk drive interface 754a, an optical drive interface 756a, a USB drive interface 745a, and a scanner interface 758a operate to connect bus 724 to hard disk drive 752, magnetic disk drive 754, optical disk drive 756, USB drive 745 and scanner 758, respectively. Each of these drive components and their associated computer-readable media may provide computer 712 with non-volatile storage of computer-readable instruction, program modules, data structures, application programs, an operating system, and other data for computer 712. In addition, it will be understood that computer 712 may also utilize other types of computer-readable media in addition to those types set forth herein, such as digital video disks, random access memory, read only memory, other types of flash memory cards, magnetic cassettes, and the like.

Computer 712 may operate in a networked environment using logical connections with network 702. Network interface 728 provides a communication path 760 between bus 724 and network 702, which allows, for example, interaction data, generated actionable insights, calculated/predicted scores, and other information to be communicated to a server or database for storage, further analysis, and allowing access to users. The interaction data, insights, scores and other related information may also be communicated from bus 724 through a communication path 762 to network 702 using serial port 732 and a modem 764. It will be appreciated that the network connections shown herein are merely example, and it is within the scope of the present invention to use other types of network connections between computer 712 and network 702 including both wired and wireless connections.

In one aspect, the present invention is directed to a system for providing an artificial intelligence (AI) and machine learning (ML) powered customer experience intelligence platform. The platform includes a memory storing computer-executable instructions and a processor configured to execute the computer-executable instructions to perform a method. The method includes collecting interaction data and metadata associated with interaction(s) between a customer computing device(s) and an agent computing device(s). The method further includes generating a transcript for an interaction(s) based on the collected interaction data and metadata; and applying AI machine learning (AI/ML) model(s) to a generated transcript(s) to perform deep analytics and interaction monitoring thereon to generate interaction insights for the generated transcript(s). Based on the generated interaction insight(s), the method predicts score(s) for rating agent behavior during the interaction(s), e.g., each interaction, and displaying the predicted score(s) and the generated interaction insight(s) in a graphical user interface (GUI).

In one example, the processor may be configured to generate the generated interaction insight(s) using: sentiment analytics; generic AI/ML model(s) based on agent behaviors; contact metadata including silence time, agent time, customer time, transcription, and/or search. In another example, the processor may be further configured to generate the interaction insight(s) utilizing topic analysis or word clouds and/or customer dissatisfaction (DSAT) analytics. In a further example, the processor may be further configured to perform quality monitoring automation using custom AI/ML model(s) for quality parameters and displaying an agent and team leader-board with adherence key performance indicators (KPIs) on the GUI. In yet another example, the processor may be further configured to predict customer experience outcome(s) (pOutcomes) using the custom AI/ML model(s). In another example, the processor may be further configured to display in the GUI a contact reasons leader-board with pOutcomes KPIs and an agent and team leader-board with pOutcomes KPIs. In a further example, the custom AI/ML models(s) may include computer implemented model(s) trained for predicting net promoter score (NPS)/customer satisfaction (CSAT) and resolution, and computer implemented model(s) trained for performing survey feedback analysis.

In one example the system may provide the ability to communicate coaching feedback input using a coach computing device based on the predicted score(s) and the generated interaction insight(s), and allows for the communication of comments between the agent(s) computing device and the coach computing device(s) in connection with the coaching feedback, in real-time during or after an interaction via the GUI. In another example, the system may further allow for creating and managing goal(s) for agents based on predicted score(s), the generated interaction insight(s), and the coaching feedback. The method may further include tracking progress of the goal(s) and, in one example, rewarding agents upon completion of the goals.

In another aspect, the present invention is directed to a computer-implemented method using an artificial intelligence (AI) and machine learning (ML) powered customer experience intelligence platform. The method includes collecting interaction data and metadata associated with interaction(s) between customer computing device(s) and agent computing device(s), generating a transcript for an interaction(s) based on the collected interaction data and metadata, and applying AI machine learning (AI/ML) model(s) to a generated transcript(s) to perform deep analytics and interaction monitoring thereon to generate interaction insight(s) for the generated transcript(s). Based on the generated interaction insight(s), the method predicts score(s) for rating agent behavior during the interaction(s), e.g., each interaction, and displaying the predicted score(s) and the generated interaction insight(s) in a graphical user interface (GUI).

In one example, the generated interaction insight(s) may be generated using sentiment analytics; generic AI/ML model(s) based on agent behaviors; contact metadata including silence time, agent time and/or customer time; transcription; and/or search. In another example, the interaction insight(s) may be further generated using topic analysis or word clouds, and/or customer dissatisfaction (DSAT) analytics. In still another example, the method may further include performing quality monitoring automation using custom AI/ML model(s) for quality parameters, and displaying an agent and team leader-board with adherence key performance indicators (KPIs) on the dashboard. In yet a further example, the method may further include determining predictive customer experience outcome(s) (pOutcomes) using the custom AI/ML model(s). In one example, the method may further include displaying in the GUI a contact reasons leader-board with pOutcome(s) KPI(s) and an agent and team-leader board with pOutcomes KPIs. In another example, the custom AI/ML model(s) may include computer-implemented model(s) trained for predicting net promoter score (NPS)/customer satisfaction (CSAT) and resolution and computer-implemented model(s) trained for performing survey feedback analysis.

In one example, the method may further include providing the ability to communicate coaching feedback input using a coach computing device based on the predicted score(s) and the generated interaction insight(s), and allowing for the communication of comments between the agent(s) computing device and the coach computing device in connection with the coaching feedback, in real-time during or after an interaction via the GUI. In another example, the method may also allow for creating and managing goal(s) for agents based on the predicted score(s), the generated interaction insight(s), and the coaching feedback. The method may further include tracking progress of the goal(s) and, in one example, rewarding agents upon completion of the goals.

In still another aspect, the present invention may be directed to a non-transitory computer readable medium storing programmed instructions for implementing the AI and machine learning (ML) powered customer experience intelligence platform when executed by a computer processor to perform a method. The method includes collecting interaction data and metadata associated with interaction(s) between a customer computing device(s) and an agent computing device(s), generating a transcript for an interaction(s) based on the collected interaction data and metadata, and applying AI machine learning (AI/ML) model(s) to the generated transcript(s) to perform deep analytics and interaction monitoring thereon to generate interaction insight(s) for the generated transcript(s). Based on the generated interaction insight(s), predicting score(s) for rating agent behavior during the interaction(s), e.g., each interaction, and displaying the predicted score(s) and the generated interaction insight(s) in a graphical user interface (GUI).

In one example, the method of the non-transitory computer readable medium may further include generating the generated interaction insight(s) using: sentiment analytics; generic AI/ML model(s) based on agent behaviors; contact metadata including silence time, agent time and/or customer time; transcription; and/or search. In another example, the interaction insight(s) may be further generated using topic analysis or word clouds and/or customer dissatisfaction (DSAT) analytics. In still another example, the method of the non-transitory computer readable medium may further include determining predictive customer experience outcome(s) (pOutcomes) using the custom AI/ML model(s). In yet another example, the method of the non-transitory computer readable medium may further include displaying in the GUI a contact reasons leader-board(s) with pOutcomes KPIs and an agent and team-leader board with pOutcomes KPIs. In another example, the custom AI/ML model(s) may include computer-implemented model(s) trained for predicting net promoter score (NPS)/customer satisfaction (CSAT) and resolution and computer-implemented model(s) trained for performing survey feedback analysis.

The present invention may be a system, a method, and/or a computer program product at any possible technical detail level of integration. The computer program product may include a computer readable storage medium (or media) having computer readable program instructions thereon for causing a processor to carry out aspects of the present invention.

The non-transient computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A system for providing an artificial intelligence (AI) and machine learning (ML) powered customer experience intelligence platform comprising:
a memory storing computer-executable instructions; and
a processor configured to execute the computer-executable instructions to perform a method, the method comprising:
collecting interaction data and metadata associated with one or more interactions between at least one customer computing device and at least one agent computing device, the collecting resulting in collected interaction data and metadata;
generating a transcript for at least one of the one or more interactions based on the collected interaction data and metadata, the generating resulting in one or more generated transcripts;
applying one or more AI machine learning (AI/ML) models to at least one of the one or more generated transcripts to perform deep analytics and interaction monitoring thereon to generate one or more interaction insights for the at least one of the one or more generated transcripts, resulting in one or more generated interaction insights;
based on the one or more generated interaction insights, predicting one or more scores for rating agent behavior during each of the at least one of the one or more interactions, the predicting resulting in at least one predicted score; and
displaying the at least one predicted score and the one or more generated interaction insights in a graphical user interface (GUI).

2. The system according to claim 1, wherein the processor is configured to generate the one or more generated interaction insights using one or more of:
sentiment analytics;
generic AI/ML models based on agent behaviors;
contact metadata including at least one of silence time, agent time, and customer time;
transcription; and
search.

3. The system according to claim 2, wherein the processor is further configured to generate the one or more interaction insights utilizing one or more of:
topic analysis or word clouds; and
customer dissatisfaction (DSAT) analytics.

4. The system according to claim 3, wherein the processor is further configured to perform quality monitoring automation using one or more custom AI/ML models for quality parameters and displaying an agent and team leader-board with adherence key performance indicators (KPIs) on the GUI.

5. The system according to claim 4, wherein the processor is further configured to determine one or more predictive customer experience outcomes (pOutcomes) using the one or more custom AI/ML models.

6. The system according to claim 5, wherein the processor is further configured to display in the GUI at least one of a contact reasons leader-board with pOutcomes KPIs and an agent and team leader-board with pOutcomes KPIs.

7. The system according to claim 5, wherein the one or more custom AI/ML models include one or more computer implemented models trained for predicting net promoter score (NPS)/customer satisfaction (CSAT) and resolution, and one or more computer implemented models trained for performing survey feedback analysis.

8. The system according to claim 1, wherein the system provides the ability to communicate coaching feedback input using a coach computing device based on the at least one predicted score and the one or more generated interaction insights, and allows for the communication of comments between the at least one agent computing device and the coach computing device in connection with the coaching feedback, in near real-time during or after an interaction via the GUI.

9. The system according to claim 8, wherein the system further allows for creating and managing one or more goals for agents based on at least one of the at least one predicted score, the one or more generated interaction insights, and the coaching feedback, the method further comprising tracking progress of the goals and rewarding agents upon completion of the goals.

10. A computer-implemented method using an artificial intelligence (AI) and machine learning (ML) powered customer experience intelligence platform, the method comprising:
collecting interaction data and metadata associated with one or more interactions between at least one customer computing device and at least one agent computing device the collecting resulting in collected interaction data and metadata;
generating a transcript for at least one of the one or more interactions based on the collected interaction data and metadata, the generating resulting in one or more generated transcripts;
applying one or more AI machine learning (AI/ML) models to at least one of the one or more generated transcripts to perform deep analytics and interaction monitoring thereon to generate one or more interaction insights for the at least one of the one or more generated transcripts, resulting in one or more generated interaction insights;
based on the one or more generated interaction insights, predicting one or more scores for rating agent behavior during each of the at least one of the one or more interactions, the predicting resulting in at least one predicted score; and
displaying the at least one predicted score and the one or more generated interaction insights in a graphical user interface (GUI).

11. The method according to claim 10, wherein the one or more generated interaction insights are generated using one or more of:
sentiment analytics;
generic AI/ML models based on agent behaviors;
contact metadata including at least one of silence time, agent time, and customer time;
transcription; and
search.

12. The method according to claim 11, wherein the one or more interaction insights are further generated using one or more of:
topic analysis or word clouds; and
customer dissatisfaction (DSAT) analytics.

13. The method according to claim 12, further comprising performing quality monitoring automation using one or more custom AI/ML models for quality parameters, and displaying an agent and team leader-board with adherence key performance indicators (KPIs) on the dashboard.

14. The method according to claim 13, further comprising determining one or more predictive customer experience outcomes (pOutcomes) using the one or more custom AI/ML models.

15. The method according to claim 14, further comprising displaying in the GUI at least one of a contact reasons leader-board with pOutcomes KPIs and an agent and team-leader board with pOutcomes KPIs.

16. The method according to claim 14, wherein the one or more custom AI/ML models include one or more computer-implemented models trained for predicting net promoter score (NPS)/customer satisfaction (CSAT) and resolution, and one or more computer-implemented models trained for performing survey feedback analysis.

17. The method according to claim 10, further comprising providing the ability to communicate coaching feedback input using a coach computing device based on the at least one predicted score and the one or more generated interaction insights, and allowing for the communication of comments between the at least one agent computing device and the coach computing device in connection with the coaching feedback, in near real-time during or after an interaction via the GUI.

18. The method according to claim 17, further comprising allowing for creating and managing one or more goals for agents based on at least one of the at least one predicted score, the one or more generated interaction insights, and the coaching feedback, the method further comprising tracking progress of the goals and rewarding agents upon completion of the goals.

19. A non-transitory computer readable medium storing programmed instructions for implementing an Artificial Intelligence (AI) and machine learning (ML) powered customer experience intelligence platform when executed by a computer processor to perform a method, the method comprising:
collecting interaction data and metadata associated with one or more interactions between at least one customer computing device and at least one agent computing device the collecting resulting in collected interaction data and metadata;
generating a transcript for at least one of the one or more interactions based on the collected interaction data and metadata, the generating resulting in one or more generated transcripts;
applying one or more AI machine learning (AI/ML) models to at least one of the one or more generated transcripts to perform deep analytics and interaction monitoring thereon to generate one or more interaction insights for the at least one of the one or more generated transcripts, resulting in one or more generated interaction insights;
based on the one or more generated interaction insights, predicting one or more scores for rating agent behavior during each of the at least one of the one or more interactions, the predicting resulting in at least one predicted score; and
displaying the at least one predicted score and the one or more generated interaction insights in a graphical user interface (GUI).

20. The non-transitory computer readable medium of claim 19, wherein the one or more generated interaction insights are generated using one or more of:
sentiment analytics;
generic AI/ML models based on agent behaviors;
contact metadata including at least one of silence time, agent time, and customer time;
transcription; and
search.

21. The non-transitory computer readable medium of claim 20, wherein the one or more interaction insights are further generated using one or more of:
topic analysis or word clouds; and
customer dissatisfaction (DSAT) analytics.

22. The non-transitory computer readable medium of claim 21, further comprising determining one or more predictive customer experience outcomes (pOutcomes) using the one or more custom AI/ML models.

23. The non-transitory computer readable medium of claim 22, further comprising displaying in the GUI at least one of a contact reasons leader-board with pOutcomes KPIs and an agent and team-leader board with pOutcomes KPIs.

24. The non-transitory computer readable medium of claim 22, wherein the one or more custom AI/ML models include one or more computer-implemented models trained for predicting net promoter score (NPS)/customer satisfaction (CSAT) and resolution, and one or more computer-implemented models trained for performing survey feedback analysis.
